(19) United States
(12) Patent Application Publication
(10) Pub. No.: US 2009/0053409 A1
(43) Pub. Date: Feb. 26, 2009

(54) RECORDING MEDIUM, METHOD FOR PRODUCING THE SAME, AND INKJET RECORDING METHOD USING THE RECORDING MEDIUM

(75) Inventors: Hiroshi YAMAMOTO, Kanagawa (JP); Yusuke Nakazawa, Kanagawa (JP); Kaoru Tojo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/196,320

(22) Filed: Aug. 22, 2008

(30) Foreign Application Priority Data
Aug. 24, 2007 (JP) 2007-219068
Nov. 19, 2007 (JP) 2007-299881

(51) Int. Cl. B05D 5/04; B05D 3/02; B41M 5/50

(52) U.S. Cl. 427/195; 428/32.18; 427/288

(57) ABSTRACT

The present invention provides a recording medium which contains a base paper, a first layer containing a binder, and a second layer containing a white pigment, the first layer and second layer being laid in this order on the base paper, wherein the base paper provided with the first layer on its surface has a Cobb water absorption degree, measured according to a water absorption test prescribed in JIS P8140 with a contact time of 15 seconds, of 5.0 g/m² or lower, and the second layer has an amount of water absorbed therein, measured by the Bristow's method with a contact time of 0.5 seconds, of 2 mL/m² to 8 mL/m².

### BACKGROUND OF THE INVENTION

1. Field of the Invention

The present invention relates to a recording medium, a method for producing the recording medium, and an inkjet recording method using the recording medium.

2. Description of the Related Art

Generally, inkjet devices have a simple structure, and high-quality images can be recorded by inkjet recording using such an inkjet device. Inks used in inkjet recording are generally designed so as to have a viscosity of about several mPa·s to 30 mPa·s and a surface tension of about 20 mN/m to 40 mN/m.

Usually, 50% by mass to 90% by mass of an ink solvent is contained in an ink so that the ink viscosity is within the above-mentioned range. As such an ink solvent, water, organic solvent, oil, photopolymerizable monomer and the like are used. Particularly, water is frequently used from the perspective of environmental applicability. Further, an ink solvent generally contains a solvent having high-boiling point such as glycerin so as not to cause nozzle clogging of each inkjet head due to desiccation of the ink solvent.

In the meanwhile, on a recording medium having an ink image formed on its surface, the use of a large amount of ink solvent causes image bleeding and inter-color mixing of neighboring colors. For this reason, by using inkjet recording paper having on its surface a solvent absorption layer (ink receiving layer) which absorbs approximately 20 μm to 30 μm of ink solvent (reference numeral 200 in FIG. 5) as a recording medium, the occurrence of image bleeding and inter-color mixing is prevented.

Further, in the case of an aqueous ink using water as an ink solvent, at the time of recording, infiltration of water into base paper causes paper deformation such as curling and/or cockling, however, as shown in FIG. 5, the use of a recording medium having a solvent absorption layer 22 formed on a base paper 21 makes it possible to prevent water from infiltrating into the base paper 21 and therefore to prevent the paper deformation.

Meanwhile, when a graphic image having high-image density and high image area ratio is formed, the amount of ink per unit area is greater, a solvent absorption layer cannot prevent an ink solvent from infiltrating into base paper. To prevent this, waterproof paper containing a waterproof layer such as polyolefin layer (e.g., laminate paper) is used (see Japanese Patent Application Laid-Open (JP-A) Nos. 2005-238829 and 2005-96285, for example).

Inkjet technologies have been used in the field of office printers, home printers and the like, however, are recently becoming used in applications in the field of commercial printing. In the field of commercial printing, recording media having printing texture like those of general-purpose printing paper are required, not recording media having such a surface that completely shuts out infiltration of ink solvents into base paper, as seen in photograph. When a solvent absorption layer in a recording medium is formed as thick as 20 μm to 30 μm, the surface glossiness, texture, rigidity (stiffness) and the like of the recording medium are restricted, and thus applications of inkjet technologies in the field of commercial printing are limited to posters, business forms and slips, which allow for removing the restrictions on the surface glossiness, texture, rigidity (stiffness) and the like. Further, recording media having a solvent absorption layer and/or a waterproof layer result in high costs, and this also contributes to the above-noted restrictions.

Japanese Patent Application Laid-Open (JP-A) No. 2007-130791 discloses a method of producing an inkjet recording medium in which at least an under layer and an upper layer are provided on a support, followed by casting to form a recording medium, the under layer contains a water-absorbing inorganic pigment, a binder composed of latex, and a boric acid or borate, the upper layer contains a submicron pigment and a polyvinyl alcohol, and after a state where the surface pH of the upper layer is 8 or higher is obtained and then the pH is adjusted to 5.5 or lower using a liquid containing acids.

However, in the method described in JP-A No. 2007-130791, when an image is formed using an ink, water contained in the ink penetrates through a blocking layer and reaches base paper because of its insufficient blocking ability of the blocking layer, resulting in occurrence of cockling and/or curling. Further, since the surface pH of the upper layer before pH adjustment is as high as 8, the recording medium has buffer ability even by adjusting the pH using acids, coloring materials dissolved or dispersed in the ink are slow to agglomerate, causing a problem of degradation of image quality due to image bleeding and deformation of droplets after ink droplet landing.

Further, Japanese Patent Application Laid Open (JP-A) No. 06-219044 proposes a recording paper, which is an alkaline paper, and on which recording is performed by using an aqueous recording liquid containing a dye that changes its solubility from being water-soluble to being water-insoluble depending on a pH change, in which the surface pH is adjusted to a pH or lower value at which the dye becomes soluble in water.

Furthermore, Japanese Patent Application Laid-Open (JP-A) No. 08-244337 proposes an inkjet recording paper on which recording is performed with an ink using an aqueous dye having primarily carboxyl groups as hydrophilic functional groups, and the inkjet recording paper has a base paper containing no calcium carbonate but containing kaolin and/or illite as fillers, and a recording layer which is formed at least one surface of the base paper, contains a water-absorbing pigment and an aqueous binder as main components and has a solid content of 0.5 g/m² to 3.0 g/m² per one surface.

However, the recording media disclosed in Japanese Patent Application Laid Open (JP-A) Nos. 06-219044 and 08-244337 respectively have a problem that ink-water reaches base paper to cause cockling and/or curling.

### BRIEF SUMMARY OF THE INVENTION

The present invention aims to solve the conventional problems described above and to achieve the following object. Specifically, the present invention aims to provide a recording medium capable of printing with quality as high as that obtained by offset printing at high speed and at inexpensive production cost, a method for producing the recording medium, and an inkjet recording method using the recording medium.

The means for solving the above-mentioned conventional problems are as follows:

<1> A recording medium comprising:

a base paper,

a first layer containing a binder, and

a second layer containing a white pigment, the first layer and second layer being laid in this order on the base paper,

wherein the base paper provided with the first layer on its surface has a Cobb water absorption degree, measured according to a water absorption test prescribed in JIS P8140 with a contact time of 15 seconds, of 5.0 g/m² or lower, and the second layer has an amount of water absorbed therein, measured by the Bristow's method with a contact time of 0.5 seconds, of 2 mL/m² to 8 mL/m².

<2> The recording medium according to the item <1>, wherein the base paper provided with the first layer on its surface has a Cobb water absorption degree, measured according to a water absorption test prescribed in JIS P8140 with a contact time of 2 minutes, of 2.0 g/m² or lower.

<3> The recording medium according to any one of the items <1> to <2>, wherein the base paper provided with the first layer on its surface has a Cobb value, measured based on a water absorption test prescribed in JIS P8140 using diethylene glycol with a contact time of 2 minutes, of 5.0 g/m² or lower, and the second layer has an amount of water absorbed, measured by the Bristow's method using pure water containing 30% by mass of diethylene glycol with a contact time of 0.9 seconds, of 1 mL/m² to 6 mL/m².

<4> The recording medium according to any one of the items <1> to <3>, wherein before pH adjustment, the second layer has a layer surface pH of less than 8.0.

<5> The recording medium according to any one of the items <1> to <4>, wherein the white pigment is comprised only of a white pigment which has a pH, measured by a pH test method based on a cold-water extraction method prescribed in JIS K5101, of less than 8.0.

<6> The recording medium according to any one of the items <1> to <5>, wherein the white pigment has a pH, measured after adding 0.1 mL of a liquid containing 1 moL/L of hydrochloric acid to 10 g of a measurement sample of the pigment according to a pH test method based on a cold-water extraction method prescribed in JIS K5101, of less than 6.0.

<7> The recording medium according to any one of the items <1> to <6>, wherein after pH adjustment, the second layer has a layer surface pH of 5.5 or lower.

<8> The recording medium according to any one of the items <1> to <7>, wherein the binder contained in the first layer comprises a thermoplastic resin.

<9> The recording medium according to the item <8>, wherein the thermoplastic resin is at least one selected from polyester urethane latexes, and acrylic silicone latexes.

<10> The recording medium according to any one of the items <1> to <9>, wherein the first layer further comprises a laminar inorganic compound.

<11> The recording medium according to any one of the items <1> to <10>, wherein the first layer further comprises a white pigment.

<12> The recording medium according to the item <11>, wherein the white pigment is kaolin.

<13> The recording medium according to the item <12>, wherein the kaolin has an aspect ratio of 30 or more.

<14> A method for producing a recording medium, comprising:

forming a first layer on a surface of a base paper, and

forming a second layer on a surface of the first layer to thereby produce a recording medium,

wherein in the formation of the first layer, thermoplastic resin fine particles provided on the surface of the base paper are heated in the range of temperature which is higher than the minimum film forming temperature of the thermoplastic resin fine particles, and

wherein the recording medium is the recording medium according to any one of the items <1> to <13>.

<15> The method according to the item <14>, wherein when a shearing rate D(=S/(t×60×10⁻⁶)) of a coating solution for forming a second layer, which is defined depending on a coating rate S (m/min) and a film thickness t (μm) of a coated layer, is within the range of from 10³ (s⁻¹) to 10⁶ (s⁻¹), the high-shear viscosity of the coating solution for forming a second layer is from 20 mPa·s 150 mPa·s.

<16> The method according to any one of the items <14> to <15>, wherein in the formation of the second layer, a coating solution for forming a second layer is applied onto the first layer by a blade coating method.

<17> An inkjet recording method comprising:

forming an ink image based on predetermined image data on a surface of a recording medium, and

drying an ink solvent in the recording medium having the ink image formed on the surface thereof so as to remove the ink solvent,

wherein the recording medium is the recording medium according to any one of the items <1> to <13>.

<18> An inkjet recording method comprising:

supplying a treatment liquid containing an acidic material to a recording medium,

forming an ink image based on predetermined image data on a surface of the recording medium, and

drying an ink solvent in the recording medium having the ink image formed on the surface thereof so as to remove the ink solvent,

wherein the recording medium is the recording medium according to any one of the items <1> to <13>.

The present invention can solve the above-mentioned conventional problems and achieve the object. Namely, the present invention can provide a recording medium capable of printing with quality as high as that obtained by offset printing at high speed and at inexpensive production cost, a method for producing the recording medium, and an inkjet recording method using the recording medium.

### BRIEF DESCRIPTION OF THE SEVERAL VIEWS OF THE DRAWINGS

FIG. 1 is a view for explaining a recording medium of the present invention.

FIG. 2 is a view for explaining an inkjet recording method (mode 1) using a recording medium of the present invention.

FIG. 3 is a view for explaining an inkjet recording method (mode 2) using a recording method of the present invention.

FIG. 4 is a view for explaining a scanning line of a head filled with a test liquid according to the Bristow's method.

FIG. 5 is a view for explaining a conventional recording medium.

### DETAILED DESCRIPTION OF THE INVENTION

Hereinafter, a recording medium of the present invention, a method for producing the recording medium, and an inkjet recording method using the recording medium will be described with reference to drawings.

### (Recording Medium)

A recording medium of the present invention has a first layer and a second layer and further has other layers suitably selected in accordance with the necessity.

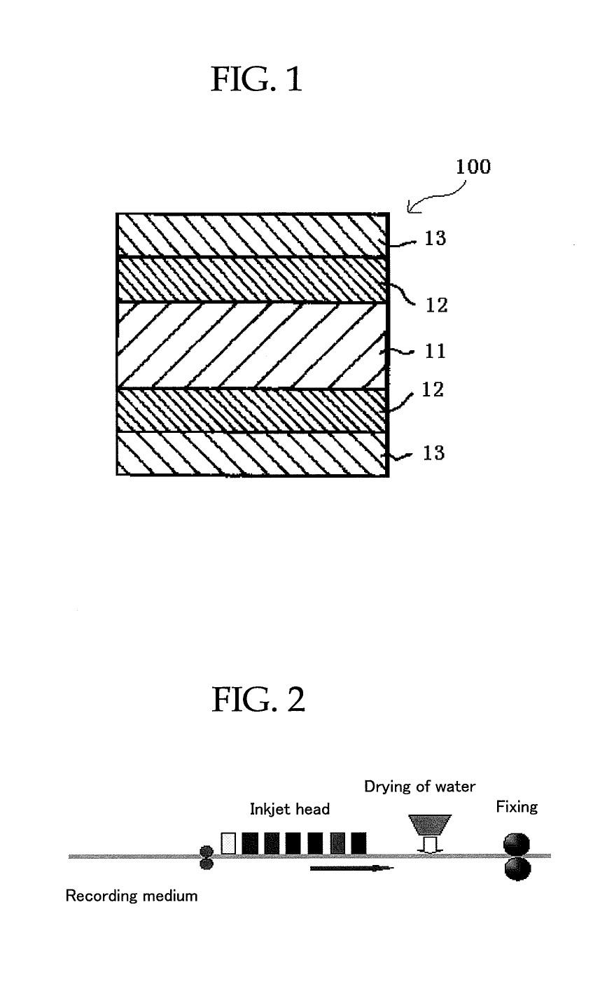

For instance, as shown in FIG. 1, a recording medium 100 has a high-quality paper 11 as a base paper, a solvent blocking layer 12 as a first layer formed on the high-quality paper 11 and an ink absorption layer 13 as a second layer formed on the solvent blocking layer 12.

The recording medium 11 may be any one of a sheet paper or roll paper.

### <Base Paper>

The base paper is not particularly limited and may be suitably selected from among those known in the art in accordance with the intended use.

As a pulp used as a raw material of the base paper is preferred to be a broad-leaf tree bleached kraft pulp (LBKP), from the view point of simultaneously improving surface planarity, rigidity, and dimension stability (curling property) of the base paper in a good balance and to a sufficient level. A needle-leaf tree bleached kraft pulp (LBKP) and a broad-leaf tree sulfite pulp (LBSP) and the like are usable as well.

A beater, a refiner or the like can be used for beating the pulp. When necessary, various types of additives can be added to a pulp slurry (hereinafter referred to as “pulp paper material” as the case may be) which can be obtained after beating the pulp. Examples of the additives include fillers, dry paper reinforcers, sizing agents, wet paper reinforcers, fixing agents, pH regulators, and other agents.

Examples of the fillers include calcium carbonate, clay, kaolin, white clay, talc, titanium oxide, diatomaceous earth, barium sulfate, aluminum hydroxide, and magnesium hydroxide. Examples of the dry paper reinforcers include cationic starch, cationic polyacrylamide, anionic polyacrylamide, amphoteric polyacrylamide, and carboxy-modified polyvinyl alcohol. Examples of the sizing agents include rosin derivatives such as fatty acid salt, rosin, and maleic rosin; paraffin wax, alkyl ketene dimer, alkenyl succinic anhydride (ASA); and epoxy fatty acid amide.

Examples of the wet paper reinforcers include polyamine polyamide epichlorohydrin, melamine resins, urea resins, and epoxy polyamide resins. Examples of the fixing agents include polyvalent metallic salts such as aluminum sulfate, aluminum chloride; and cationic polymers such as cationic starch. Examples of the pH regulators include caustic soda, and sodium carbonate.

Examples of other agents include a defoaming agent, a dye, a slime control agent, a fluorescent whitening agent. Further, a softener may also be added when necessary. For the softener, for example, those disclosed on pp. 554-555 of “Paper and Paper Treatment Manual” (published in 1980, compiled by Shiyaku Time Co., Ltd.) can be used.

A surface treatment liquid used in the surface sizing treatment may include a water-soluble high molecular compound, sizing agent, waterproof material, pigment, pH regulator, dye, and fluorescent whitening agent. Examples of the water-soluble high molecular compound include cationic starch, polyvinyl alcohol, carboxy-modified polyvinyl alcohol, carboxymethyl cellulose, hydroxymethyl cellulose, cellulose sulfate, gelatin, casein, sodium polyacrylate, styrene-maleic acid anhydride copolymer sodium salt, and sodium polystyrene sulfonate.

Examples of the sizing agent include petroleum emulsion, ammonium salts of alkyl esters of alkylester styrene-maleic anhydride copolymer, rosin, higher fatty acid salt, alkyl ketene dimer (AKD), and epoxy fatty acid amide.

Examples of the waterproof materials include latex emulsions such as styrene-butadiene copolymer, ethylene-vinyl acetate copolymer, polyethylene, and vinylidene chloride copolymer; and polyamide polyamine epichlorohydrin.

Examples of the pigments include calcium carbonate, clay, kaolin, talc, barium sulfate, and a titanium oxide. Examples of the pH regulators include hydrochloric acid, caustic soda, and sodium carbonate.

Examples of materials of base paper include, besides the natural pulp papers described above, synthetic pulp paper, machined paper obtained by mixing natural pulp with synthetic pulp, and various mixed type of machined paper. The thickness of the base paper is generally 30 μm to 500 μm, preferably 50 μm to 300 μm, and still more preferably 70 μm to 200 μm.

### <First Layer>

The first layer is not particularly limited and may be suitably selected from among those known in the art in accordance with the intended use, as long as the first layer contains a binder, and a base paper provided with the first layer on its surface has a Cobb water absorption degree, measured according to a water absorption test prescribed in JIS P8140 with a contact time of 15 seconds, of 5.0 g/m² or lower. For example, the following are preferred: a base paper provided with the first layer on its surface has a Cobb water absorption degree, measured according to a water absorption test prescribed in JIS P8140 with a contact time of 2 minutes, of 2.0 g/m² or lower; a base paper provided with the first layer on its surface has a Cobb value, measured based on a water absorption test prescribed in JIS P8140 using diethylene glycol with a contact time of 2 minutes, of 5.0 g/m² or lower; the binder contains at least any one of a thermoplastic resin and a polyvinyl alcohol (in particular, an acetoacetyl-modified polyvinyl alcohol having a polymerization degree of 1,000 or higher is preferable); the first layer further contain a layered inorganic compound; a mass ratio X/Y of a mass ratio X of the polyvinyl alcohol to a mass ratio Y of a water swellable synthetic mica as the layered inorganic compound is from 1 to 30; the first layer further contains a film hardener; the first layer further contains a white pigment; and the like.

The use of a base paper provided with a solvent blocking layer (the first layer) which has Cobb water absorption degree, measured according to a water absorption test prescribed in JIS P8140 with a contact time of 15 seconds, of 5.0 g/m² or lower makes it possible to prevent paper deformation caused by a degradation of paper strength and/or swelling. It is desired that when the Cobb water absorption degree, measured according to a water absorption test prescribed in JIS P8140 with a contact time of 2 minutes, of 2.0 g/m² or lower and the Cobb value, measured based on a water absorption test prescribed in JIS P8140 using diethylene glycol with a contact time of 2 minutes, of 5.0 g/m² or lower, it is possible to substantially suppress a deformation that could be caused by a degradation of paper strength and/or swelling.

As a specific method of obtaining the above-mentioned effect, by applying as a main component a water-dispersible latex, in which water insoluble or sparingly water-soluble hydrophobic polymer is dispersed as fine particles in an aqueous phase dispersion medium, over surfaces of the first layer in a solid content of 3 g/m² to 20 g/m² per one surface, almost complete water resistance can be obtained.

In order to impart hydrophilicity to the resin surface with such a degree that does not repel water, a solvent blocking layer is formed in which 5 parts by mass to 50 parts by mass of a white pigment is contained based on 100 parts by mass of the binder. By doing so, it is possible to readily apply a second layer coating solution thereonto and to obtain a base paper provided with a first layer capable of satisfying both water resistance and hydrophilicity on the above level.

In the case of a white pigment having an aspect ratio of 30 or more, the white pigment can be added up to 200 parts by mass per 100 parts by mass of the binder. With the use of such a white pigment in this amount, not only a second layer coating solution is readily applied thereonto so as to form a second layer but also the handleability of the recording medium, in particular, the cleaning performance is improved.

### <<Binder>>

The binder contained in the first layer is not particularly limited as long as it contains at least any one of a thermoplastic resin and a polyvinyl alcohol. However, the binder preferably contains a thermoplastic resin.

### <<Thermoplastic Resin>>

The thermoplastic resin is not particularly limited and may be suitably selected from among conventionally known thermoplastic resins such as polyolefin resins (for instance, monopolymers of α-olefin such as polyethylene, and polypropylene or mixtures thereof) and latexes thereof for use. Of these, latexes are preferable. Preferred examples of the latexes include polyester urethane latexes, acrylic latexes, acrylic silicone latexes, acrylic epoxy latexes, acrylic styrene latexes, acrylic urethane latexes, styrene-butadiene latexes, acrylonitrile-butadiene latexes, and vinyl acetate latexes. It is preferable to select at least one from the latexes described above and use it. Of these latexes, it is preferable to select at least one from polyester urethane latexes and acrylic silicone latexes and use it.

Specific examples of the polyester urethane latexes include HYDRAN AP series and HYDRAN ECOS series manufactured by Dainippon Ink and Chemicals, Inc.

For the acrylic latexes, commercially available products can also be used, for example, the following water-dispersible latexes can be utilized. Specific examples of acrylic resins are “CEVIAN A4635, 46583 and 4601” manufactured by DAICEL CHEMICAL INDUSTRIES, LTD.; and “NIPOL LX811, 814, 821, 820, and 857” manufactured by Nippon Zeon Co., Ltd.) and so on.

In particular, acrylic emulsions of acrylic silicone latexes described in Japanese Patent Application Laid Open (JP-A) Nos. 10-264511, 2000-43409, 2000-343811 and 2002-120452 can be suitably used. Examples of commercially available products thereof are “AQUABRID series UM7760, UM7611, UM4901, MSi-045, ASI-753, ASI-903, ASI-89, ASI-91, ASI-86, 4635, MSi-04S, AU-124, AU-131, AEA-61, AEC-69 and AEC-162” manufactured by DAICEL CHEMICAL INDUSTRIES, LTD.

The above-mentioned thermoplastic resins may be used alone or in combination.

The glass transition temperature (Tg) of the thermoplastic resin is preferably 5° C. to 70° C., and more preferably 15° C. to 50° C. By predetermining the glass transition temperature (Tg) within the range, there is little difficulty in handleability of a liquid for forming the first layer (e.g. coating solution) during production, like a problem with attachment of dried components of the coating solution, and high-glossiness and high-planarity can be readily obtained without causing such troubles that a desired glossiness cannot be obtained unless the calender temperature is set substantially high in accordance with the excessively high-glass transition temperature (Tg), and adhesion to a surface of a metal roll is likely to occur, on the contrary, the surface condition becomes poor, or the like.

The minimum film forming temperature of the thermoplastic resin is preferably 20° C. to 60° C., and more preferably 25° C. to 50° C. By predetermining the minimum film forming temperature range at the time of forming a first layer so as to be within the range, the difficulty in handleability of a liquid for forming the first layer (e.g. coating solution) during production, such as attachment of dried components of the coating solution is eliminated, and it is possible to from a layer having sufficient microporousity, through which ink solvents quicldy permeate, without causing degradation in surface condition of the coated surface of the layer due to a large amount of infiltration of a second layer coating solution when a second layer is formed thereon. A layer whose surface is only applied with a liquid (e.g. coating solution) is not actually provided with excellent glossiness, however, subsequently, by subjecting the layer surface to soft calender treatment, a layer having excellent glossiness provided with microporousity can be obtained.

When a composition for forming a first layer or the first layer coating solution is formed in the form of a layer, the amount of the thermoplastic resin contained in the first layer is preferably 15% by mass to 95% by mass and more preferably 30% by mass to 90% by mass based on the solid content of the first layer. By setting the use amount of the first layer coating solution within the above-noted range, it is possible to obtain permeability of ink solvents without impairing the glossiness and planality of the recording medium after being subjected to calender treatment as well as to efficiently prevent occurrence of ink bleed with a lapse of time.

### <<Polyvinyl Alcohol>>

As the polyvinyl alcohol, besides polyvinyl alcohols (PVA), cation-modified polyvinyl alcohols, anion-modified polyvinyl alcohols, silanol-modified polyvinyl alcohols, acetoacetyl-modified polyvinyl alcohol and other polyvinyl alcohol derivatives are included. These polyvinyl alcohols may be used alone or in combination. Of these, polyvinyl alcohol and acetoacetyl-modified polyvinyl alcohol are preferably used.

The polyvinyl alcohol used in the present invention preferably has a saponification degree of 70% to 99% and more preferably has a saponification degree of 85% to 99%. The polyvinyl alcohol preferably has a polymerization degree of 1,000 to 4,500 and more preferably has a polymerization degree of 1,500 to 4,500. By predetermining the saponification degree and the polymerization degree of the polyvinyl alcohol within the above-noted ranges, it is possible to obtain sufficient film strength and extensibility.

### <<Acetoacetyl-Modified Polyvinyl Alcohol>>

An acetoacetyl-modified polyvinyl alcohol can be produced by adding diketene in the form of a liquid or gas into a solution, a dispersion liquid or a powder of a polyvinyl alcohol resin to react with each other. The acetylation degree of the acetoacetyl-modified polyvinyl alcohol can be suitably selected in accordance with the intended quality of the thermosensitive recording material, however, it is preferably 0.1 mol % to 20 mol %, and more preferably 0.5 mol % to 10 mol %.

The polyvinyl alcohol resin contains a polyvinyl alcohol that can be obtained by saponification of a lower alcohol solution of polyvinyl acetate, the derivatives thereof, and a saponification product of a copolymer between a monomer polymerizable with a vinyl acetate and the polyvinyl acetate. Examples of the monomer copolymerizable with vinyl acetate include unsaturated carboxylic acids such as maleic acid (anhydride), fumaric acid, crotonic acid, itaconic acid, (meth)acrylic acid and esters thereof; α-olefins such as ethylene, and propylene; olefin sulfonates such as (meth)allyl sulfonate, ethylene sulfonate, and sulfonate maleate; olefin sulfonate alkali salts such as sodium (meth)allyl sulfonate, sodium ethylene sulfonate, sodium sulfonate (meth)acrylate, sodium sulfonate (monoalkyl maleate), and sodium disulfonate alkyl maleate; amide group-containing monomers such as N-methylol acrylamide and acrylamide alkyl sulfonate alkali salts; and N-vinylpyrolidone derivatives.

For the binder, besides the above-mentioned acetyl-modified polyvinyl alcohol, a compound that is soluble in water with 5% by mass or more at a temperature of 25° C. may be additionally used in accordance with the necessity. Examples of the binder include polyvinyl alcohols (including modified polyvinyl alcohols such as carboxy acid-modified, itaconic acid-modified, maleic acid-modified, silica-modified polyvinyl alcohols and the amino group-modified polyvinyl alcohols); methyl celluloses, carboxy methyl celluloses; starches (including modified starches); gelatins; gum arabic; casein, hydrolysates of styrene-maleic anhydride copolymers; polyacrylamides; and saponification products of vinyl acetate-polyacrylic acid copolymers. These binders are used for the purpose of not only dispersion but also improving the film strength of the coating solution. In order to achieve the purpose, a synthetic polymer latex binder such as styrene-butadiene copolymer, vinyl acetate copolymer, acrylonitrile-butadiene copolymer, methyl acrylate-butadiene copolymer and polyvinylidene chloride can be used in combination. Further, crosslinkers suitable for the type of the binder may be added if necessary.

The acetoacetyl-modified polyvinyl alcohol to be contained in the first layer highly prevents oxygen from permeating through the first layer and has high S—S property. In the present invention, the S—S property means an amount of tensile energy absorption (toughness) represented by tensile stress-elongation measured until the time when the film fractures. Therefore, the first layer is expandable even under a treatment requiring heating and do not cause cracks and is least likely to cause blisters.

In the present invention, the polymerization degree of the acetoacetyl-modified polyvinyl alcohol is preferably 1,000 or more, and more preferably 1,500 or more. An acetoacetyl-modified polyvinyl alcohol having a polymerization degree of 1,000 or more has an effect of largely preventing occurrence of cracks under low-humidity environments (e.g. at 20° C. and 10% RH). This is attributable to the fact that the film strength and extensibility can be remarkably improved at the time of fracture by making the acetoacetyl-modified polyvinyl alcohol have a relatively high polymerization degree of 1,000 or more. When the polymerization degree is set high, the viscosity of the coating solution is increased, which leads to a degradation of the coated surface condition. However, the shortcoming can be removed by decreasing the concentration of the coating solution and the mass ratio of water-dispersible mica therein.

The modification rate of the acetoacetyl-modified polyvinyl alcohol is preferably 0.05 mol % to 20 mol % and more preferably 0.05 mol % to 15 mol % from the perspective of the water resistance obtained by reaction with a film hardener used and the stability in an aqueous solution.

The saponification degree of the acetoacetyl-modified polyvinyl alcohol is not particularly limited, however, it is preferably 80% to 99.5%. When the saponification degree is low, the elongation amount is increased at the time of fracture, and when the polymerization degree is set high, the saponification degree is increased, however, when the polymerization degree of the acetoacetyl-modified polyvinyl alcohol is low, it is preferable that the saponification degree be set low. Further, when the saponification degree is set low, the elongation amount is greatly increased, however, it is advantageous in that the viscosity of the coating solution can be lowered, and the leveling property of the coated surface can be enhanced, thereby improving the coated surface condition.

### <<Cobb Water Absorption Degree>>

The Cobb water absorption degree is a value obtained by the water absorption test defined in JIS P8140 and determined by measuring the amount of water absorbed from one side surface of paper when the surface is made contact with water for a certain time. Note that in the present invention, the contact time was predetermined as 15 seconds and 2 minutes.

### <<Cobb Value>>

The Cobb value is determined by measuring the amount of diethylene glycol absorbed from one side surface of paper, based on the water absorption test method defined in JIS P8140 when the surface is made contact with diethylene glycol for a certain contact time. Note that in the present invention, the contact time was predetermined as 2 minutes.

### <<Layered Inorganic Compound>>

Preferably, the first layer further contains a layered inorganic compound. The layered inorganic compound is preferably a swellable layered inorganic compound. Examples of the swellable layered inorganic compound include swelling clay minerals such as bentonite, hectorite, saponite, beedelite, nontronite, stibnite, beidellite, montmorillonite; swellable synthetic mica, and swellable synthetic smectite. These swellable layered inorganic compounds respectively has a laminate structure composed of crystal lattice layers having a thickness of 1 nm to 1.5 nm, the degree of metal atom substitution in the lattice is significantly higher than that of other clay minerals. As a result, a shortage of positive charges arises in the lattice layer and in order to compensate therefor, a cation such as Na⁺, Ca²⁺ and Mg²⁺ is adsorbed between the layers. This cation present between the layers is called an exchangeable cation and can be exchanged with various cations. Particularly, in the case where the cation between the layers is Li⁺ or Na⁺, the ion radius is small, therefore, the bond between the layered crystal lattices is weak to allow for great swelling with water. When shearing is applied in this state, the bond is readily cleaved, and a sol which is stable in water is formed. The bentonite and swelling synthetic mica strongly show this tendency and are useful in the present invention. In particular, a water swelling synthetic mica is preferred.

As the water swellable synthetic mica, Na tetrasilicic mica NaMg_{2.5} (Si₄O₁₀)F₂Na, Li taeniolite (NaLi)Mg₂ (Si₄O₁₀)F₂ Na or Li hectorite (NaLi)/3Mg₂/3Li_{1/3}(Si₄O₁₀)F₂ are exemplified.

With respect to the profile of the water swellable synthetic mica for use in the present invention, the thickness is from 1 nm to 50 nm and the plane size is from 1 μm to 20 μm. From the standpoint of control of diffusion, the thickness is preferably thinner and the plane size is preferably larger as long as the smoothness of the coated surface and the transparency of the recording medium are not impaired. Thus, the aspect ratio of the water swellable synthetic mica is 100 or more, preferably 200 or more, and still more preferably 500 or more.

### <<Mass Ratio>>

A mass ratio X/Y of a mass X of an acetoacetyl-modified polyvinyl alcohol contained in the first layer relative to a mass Y of the water swellable synthetic mica is preferably within the range of 1 to 30 and more preferably within the range of 5 to 15. When the mass ratio is within the range of 1 to 30, the effect of preventing oxygen permeation and the occurrence of blisters is sufficiently exerted.

### <<Film Hardener>>

The film hardener contained in the first layer of the present invention is at least one selected from aldehyde compounds, 2,3-dihydroxy-1,4-dioxane and derivatives thereof, and compounds having in a single molecule thereof two or more vinyl groups which are adjacent to substituents having a positive Hammett substituent constant σρ. By adding, as a film hardener, at least one selected from aldehyde compounds, 2,3-dihydroxy-1,4-dioxane and derivatives thereof, and compounds having in a single molecule thereof two or more vinyl groups which are adjacent to substituents having a positive Hammett substituent constant σρ in the first layer of the present invention, it is possible to obtain a reaction between the acetoacetyl-modified polyvinyl alcohol and the film hardener and to improve the water resistance of the recording material without increasing the viscosity of the first layer coating solution. As a result, it is possible to obtain a recording material whose water resistance is improved, in which the coated stability of the first layer coating solution is improved.

Examples of the substituents having a positive Hammett substituent constant up include CF₃group (σρ value: 0.54), CN group (σρ value: 0.66), COCH₃group (σρ value: 0.50), COOH group (σρ value: 0.45), COOR group (R represents an alkyl group) (σρ value: 0.45), NO₂ group (σρ value: 0.78), OCOCH₃ group(σρ value: 0.31), SH group(σρ value: 0.15), SOCH₃ group (σρ value: 0.49), SO₂CH₃ group (σρ value: 0.72), SO₂NH₂ group (σρ value: 0.57), SCOCH₃ group (σρ value: 0.44), F group (σρ value: 0.06), Cl group (σρ value: 0.23), Br group (σρ value: 0.23), I group (σρ value: 0.18), IO₂ group (σρ value: 0.76), N⁺(CH)₂ group (σρ value: 0.82), and S⁺(CH₃)₂ group (σρ value: 0.90).

Examples of the compounds having in a single molecule thereof two or more vinyl groups which are adjacent to substituents having a positive Hammett substituent constant up include 2-ethylensulfonyl-N-[2-(2-ethylenesulfonyl-acetylamino)-ethyl]acetamide, bis-2-vinylsulfonylethyl ether, bisacryloylimide, N—N′-diacryloylurea, 1,1-bisvinylsulfoneethane, ethylene-bis-acrylamide, and further include diacrylates compounds and dimethacrylate compounds represented by any of the following Chemical Formulas. Of these compounds, 2-ethylenesulfonyl-N-[2-(2-ethylenesulfonyl-acetylamino)-ethyl]acetamide is particularly preferable.

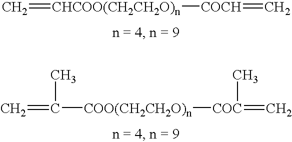

The amount of the compound having in a single molecule thereof two or more vinyl groups which are adjacent to substituents having a positive Hammett substituent constant σρ contained in the first layer is preferably from 0.1% by mass to 30% by mass and more preferably from 0.5% by mass to 10% by mass relative to the use amount of the acetoacetyl-modified polyvinyl alcohol. When the amount of the compound contained in the first layer is within the range of 0.5% by mass to 10% by mass, the effect of the compound capable of improving the water resistance of a recording material without increasing the viscosity of the first layer coating solution can be further exhibited.

### <<White Pigment>>

As to the white pigment, for example, titanium oxide, barium sulfate, barium carbonate, calcium carbonate, lithopone, alumina white, zinc oxide, silica, antimony trioxide, titanium phosphate, aluminum hydroxide, kaolin, clay, talc, magnesium oxide, and magnesium hydroxide. These white pigments may be used alone or in combination. Of these, kaolin is particularly preferable.

### <<Kaolin>>

The kaolin preferably has an aspect ratio (diameter/thickness) of 30 or more. Examples of the kaolin having an aspect ratio of 30 or more include engineered grade kaolin (for example, CONTOUR 1500 (aspect ratio: 59), and ASTRA-PLATE (aspect ratio: 34). Further, when the kaolin has a high whiteness degree and a steep particle size distribution (uniform particle size), the use of the kaolin imparts excellent whiteness property and printing applicability to various coated papers.

With respect to the particle size of the white pigment, the white pigment preferably contains particles of 2 μm or less in particle size 75% or more, and further preferably contains particles having an average particle size of 0.1 μm to 0.5 μm. By setting the particle size within the preferred range, it is possible to efficiently avoid a reduction in whiteness degree or a reduction in glossiness.

The titanium oxide may be any of rutile type and anatase type, and these titanium oxides may be used alone or may be mixed for use. Further, the titanium oxide may be produced by any of a sulfuric acid method and a chlorine method. The titanium oxide may be suitably selected from titanium oxides whose surface is coated with an inorganic material, such as those subjected to a hydrous alumina treatment, hydrous silicon dioxide treatment, or a hydrous zinc oxide treatment; titanium oxides whose surface is coated with an organic material such as trimethylol methane, trimethylol ethane, trimethylol propane, and 2,4-dihydroxy-2-methylpentane; or titanium oxides whose surface is subjected to a siloxane treatment with the use of polydimethyl siloxane, etc.

The refractive index of the white pigment is preferably 1.5 or more. In the case where a white pigment having a refractive index within the range is contained, high-quality images can be formed.

The specific surface area of the white pigment measured by a BET method is preferably less than 100 m²/g. In the case where a white pigment having a specific surface area within the above-mentioned range is contained, it is possible to prevent a second layer coating solution from infiltrating into the first layer when the second layer is formed and to improve ink absorptiveness of the second layer.

The BET method is one of methods for measuring a surface area of powder through the use of a gas phase adsorption method and is a method of determining a total surface area of 1 g of a sample from an adsorption isothermal line, i.e, a method of determining a specific surface area. As a gas to be adsorbed, usually, nitrogen gas is used, and a method of determining an amount of adsorbed from a change in pressure of an adsorbed gas or a change in volume thereof is commonly used. As well-known methods to obtain an isothermal line of multimolecular adsorption, there are Brunauer expression, Emmett expression, and Teller expression (BET expressions). On the basis of any of these expressions, an adsorption amount is determined, and then the obtained adsorption amount is multiplied by an area which one molecule that adsorbed gas occupies on the surface of a sample, thereby obtaining the surface area of the sample.

In the case where the composition or the first layer coating solution is formed in the form of a layer, the amount of the white pigment contained in the first layer varies depending on the type of white pigment, and the type of the thermoplastic resin, layer thickness and the like, however, it is preferably about 50 parts by mass to 200 parts by mass based on 100 parts by mass of the thermoplastic resin.

Note that conventionally known additives such as antioxidant may also be added to the first layer.

The film thickness of the first layer which is formed using the composition is preferably within the range of 1 μm to 30 μm, and more preferably 5 μm to 20 μm. By setting the film thickness within the range, it is possible to obtain better glossiness of the surface of the recording material that is subsequently subjected to a calender treatment and better whiteness property with a small amount of a white pigment as well as to make the handleability of the recording material, such as bending applicability, as high as that of coat paper, art paper or the like. Further, when the first layer contains white pigment(s), on the occasion of a calender treatment after application of the first layer, there is an effect of preventing the first layer from adhering to a calender.

### <Second Layer>

The second layer is not particularly limited and may be suitably selected from among those known in the art in accordance with the intended use, as long as the second layer contains a white pigment and the water absorption amount of the second layer, determined by the Bristow's method with a contact time of 0.5 seconds is 2 mL/m² to 8 mL/m². For example, the following are preferred: the water absorption amount of the second layer, determined by the Bristow's method using pure water containing 30% by mass of diethylene glycol with a contact time of 0.9 seconds is 1 mL/m² to 6 mL/m²; the second layer further contains a binder (thermoplastic resin); the first layer contains 10 parts by mass to 60 parts by mass of thermoplastic resin solid content based on 100 parts by mass of the white pigment solid content; the second layer has an acid pH at its surface, and so on.

When the water absorption amount of the second layer determined by the Bristow's method with a contact time of 0.5 seconds is higher than 8 mL/m², the absorption of ink solvent to the recording medium is fast, and an agglomeration reaction of ink is least likely to occur near the surface of the recording medium and therefore the ink is transferred to a fixing roller, causing contamination of printed sheets.

When the water absorption amount is less than 2 mL/m², an ink takes up the solvent at the time of an agglomeration reaction of the ink, causing a problem with image deformation.

When the water absorption amount of the second layer determined by the Bristow's method with a contact time of 0.9 seconds using pure water containing 30% by mass of diethylene glycol which is close to the components of an actually used ink solvent, is higher than 6 mL/m², contamination of printed sheets similarly to the above mentioned is caused. When the water absorption amount is lower than 1 mL/m², it results in an image deformation.

A specific method of obtaining the above-mentioned water absorption amounts, i.e, a method of setting the water absorption amount with a contact time of 0.5 seconds determined by the Bristow's method within 2 mL/m² to 8 mL/m², preferably, setting the water absorption amount with a contact time of 0.9 seconds determined by the Bristow's method using pure water containing 30% by mass of diethylene glycol within 1 mL/m² to 6 mL/m² is that the amount of a binder contained in the second layer is set within the range of 5 parts by mass to 15 parts by mass based on 100 parts by mass of a white pigment.

### <<White Pigment>>

The white pigment is not particularly limited and may be selected from those commonly utilized as white pigments in coat paper for printing such as calcium carbonate, kaolin, titanium dioxide, aluminum trihydroxide, zinc oxide, barium sulfate, satin white, and talc. When the second layer contains a white pigment, there is an effect of capable of retaining pigments used in the ink within the second layer. The white pigment is preferably made of only a white pigment having a pH of less than 8.0 (preferably 7.5 or less) determined according to the pH test method (cold-water extraction method) prescribed in JIS K5101. When the pH is higher than 8.0, the surface pH of the second layer is increased, typical coloring materials contained in inks have anion charges (anionic dissociable group), and thus the dissolution or dispersion of coloring materials is relatively stable, agglomeration of the coloring materials is least likely to occur, which may possibly cause a degradation of image quality due to image bleeding and deformation of droplets after ink droplet landing.

Further, the white pigment preferably has a pH of less than 6.0 (preferably 5.0 or less, still more preferably 4.0 or less) which is obtained after addition of 0.1 mL of 1 mol/L hydrochloric acid relative to 10 g of a measurement liquid of the white pigment according to the pH test method (cold-water extraction method) prescribed in JIS K5101. When the pH is higher than 6.0, the surface pH of the second layer is increased, which may possibly cause image bleeding and a degradation of image quality. When, in order to promote the agglomeration of coloring material(s), the pH of the second layer is adjusted low with the use of acids, the white pigment is neutralized, the surface pH of the second layer is increased, and therefore the effect of the pH adjustment is reduced, which may possibly cause image bleeding and a degradation of image quality.

Examples of the white pigment include kaolin, titanium oxide, and a mixture of kaolin with titanium oxide.

The amount of the white pigment contained in the second layer is preferably 50% by mss to 98% by mass, and more preferably 70% by mass to 97% by mass.

### <<Bristow's Method>>

The Bristow's method is a most popular method of measuring an amount of liquid absorbed for a short period of time, and the Japan Paper Pulp Technology Association (J′ TAPPI) employs this method. The details of the test method are described in J′ TAPPI No. 51 “Test Method for Liquid Absorption of Paper and Board”. At the time of measurement, a slit width of a head box of a Bristow tester is adjusted in accordance with the surface tension of an ink used. The amount of the ink that strikes through paper is not taken into account.

### <<Binder (Thermoplastic Resin)>>

The binder (thermoplastic resin) is not particularly limited. For example, a same binder (thermoplastic resin) as used for the first layer can be used. The amount of the binder in the second layer is preferably 2 parts by mass to 50 parts by mass, and more preferably 3 parts by mass to 30 parts by mass based on 100 parts by mass of the white pigment.

<<Layer Surface pH>>

It is possible to agglomerate ink and to improve fixing property of the ink on a recording medium by adjusting the layer surface pH of the second layer to be acidic.

The layer surface pH of the second layer before pH adjustment is preferably lower than 8.0, and more preferably 7.5 or less. When the layer surface pH before pH adjustment is 8.0 or higher, it may possibly cause image bleeding and a degradation of image quality. When, in order to promote the agglomeration reaction of coloring material(s), the pH of the second layer is adjusted low with the use of acids, the white pigment is neutralized, the surface pH of the second layer is increased, and therefore the effect of the pH adjustment is reduced, which may possibly cause image bleeding and a degradation of image quality.

Further, the layer surface pH of the second layer after pH adjustment is preferably 5.5 or lower, and more preferably 4.5 or lower. When the layer surface pH after the pH adjustment is higher than 5.5, it may possibly cause image bleeding and a degradation of image quality.

Note that the measurement of the surface pH can be carried out by the “A method (coating method)” among the film surface pH measurement methods prescribed by the Japan Paper Pulp Technology Association (J′ TAPPI). For example, the surface pH can be measured through the use of “Type MPC” paper surface pH measurement set manufactured by Kyoritsu Chemical-Check Lab., Corp., which corresponds to the A method.

In the pH adjustment, a pH adjustor may be added to the surface of the second layer with the use of a coating solution for the second layer or acids may be applied to the surface of the recording medium, however, it is preferable to apply acids to the surface of the recording medium. Specifically, it is preferable to apply a surface treatment liquid containing an acidic material to the surface of the recording medium. As the acidic material, it is possible to use, for example, phosphoric acid group, phosphonic acid group, phosphinic acid group, sulfuric acid group, sulfonic acid group, sulfinic acid group or carboxylic acid group or salts thereof. More preferably, the acidic material preferably contains a phosphoric acid group, a sulfonic acid group or a carboxylic acid group. Examples of the phosphoric acid are phosphoric acid, polyphosphoric acid, metaphosphoric acid, or derivatives thereof or salts thereof. Examples of the sulfuric acid are methane sulfonic acid, polysulfonic acid, or derivatives thereof, or salts thereof. Examples of the carboxylic acid are oxalic acid, tartaric acid, malic acid, malonic acid, citric acid, fumaric acid, maleic acid, succinic acid, salicylic acid, phthalic acid, lactic acid, acetic acid, trichloroacetic acid, chloroacetic acid, polyacrylic acid or derivatives thereof or salts thereof; and compounds having any one of a furan structure, pyrrole structure, pyrroline structure, pyrrolidone structure, pyron structure, thiophene structure, indole structure, pyridine structure and quinoline structure and further having a carboxyl group as a functional group, etc., such as pyrrolidone carboxylic acid, pyron carboxylic acid, pyrrole carboxylic acid, furan carboxylic acid, pyridine carboxylic acid, coumarinic acid, thiophene carboxylic acid, nicotinic acid or derivatives thereof, or salts thereof. Further, it is possible to use acids such as hydrochloric acid, sulfuric acid, and nitric acid.

### <Other Layers>

Other layers are not particularly limited and may be suitably selected in accordance with the intended use.

### (Method for Producing Recording Medium)

A method for producing a recording medium of the present invention includes a first layer forming step, a second layer forming step and further includes other steps suitably selected in accordance with the necessity.

### <First Layer Forming Step>

The first layer forming step is not particularly limited, except that a first layer is formed on a base paper, and thermoplastic resin fine particles provided on the surface of the base paper are heated in the range of temperature which is higher than the minimum film forming temperature of the thermoplastic resin fine particles, and may be suitably selected in accordance with the intended use. Note that in the heating treatment, a pressure may be applied to the thermoplastic resin fine particles.

The thermoplastic resin fine particles are not particularly limited and may be suitably selected from all types of particles of conventionally known thermoplastic resins. Examples of such conventionally known thermoplastic resins include general-purpose thermoplastic monopolymers composed any one of polyolefins such as polyethylene, polypropylene, and polyvinyl chloride; polyamides and polyimides; and polyesters such as polyethylene terephthalate; α-methylene aliphatic monocarboxylates such as methyl (meth)acrylate, ethyl (meth)acrylate, butyl (meth)acrylate, dodecyl (meth)acrylate, octyl (meth)acrylate, and phenyl (meth)acrylate; styrenes such as styrene, chlorostyrene, and vinyl styrene; vinyl esters such as vinyl acetate, vinyl propionate, vinyl benzoate, and vinyl butylate; vinyl ethers such as methyl vinyl ether, ethyl vinyl ether, and butyl vinyl ether; and vinyl ketones such as vinyl methyl ketone, vinyl hexyl ketone, and vinyl isopropenyl ketone, or arbitrarily selected copolymers containing any one of structural units thereof.

These types of thermoplastic resin fine particles may be used singularly or in combination.

The thermoplastic resin fine particles preferably have an average particle diameter of 10 nm to 200 nm. In the present invention, for the average particle diameter of resin particles, a value measured by a dynamic light scattering method (device: ELS-800 manufactured by Otsuka Electronics Co., Ltd.) is employed. The thermoplastic resin constituting resin fine particles preferably has a minimum film forming temperature (MFT) of 5° C. to 60° C.

The amount of the thermoplastic resin used for coating is preferably 1 g/m² to 30 g/m².

The thermoplastic resin fine particles preferably contain dispersed particles of a water-dispersible latex from the standpoint of prevention of cockling, ink bleeding with time, production applicability and so on.

In the water-dispersible latex, a hydrophobic polymer which is insoluble or sparingly soluble in water is dispersed as fine particles in an aqueous phase dispersion medium. The dispersed state may be any of the following dispersed states: a state where a polymer is emulsified or emulsion polymerized or micellar dispersed in a dispersion medium; or in a state where part of polymer molecules has a hydrophilic structure, and the molecule chains per se are emulsified in a dispersion medium; or so. Note that such a polymer latex is described in detail in “Gousei Jushi Emulsion (Synthetic Resin Emulsion)” compiled by Taira Okuda and Hiroshi Inagaki and published by Kobunshi Kankokai (1978); “Kobunshi Ratekkusu no Ouyou” compiled by Takaaki Sugimura, Yasuo Kataoka, Soichi Suzuki, and Keiji Kasahara, and published by Kobunshi Kankokai (1993); and “Kobunshi Ratekkusu no Kagaku” written by Soichiro Muroi and published by Kobunshi Kankokai (1970), etc.

Specifically, a preferred water-dispersible latex is at least one selected from acrylic latexes, acrylic silicone latexes, acrylic epoxy latexes, acrylic styrene latexes, acrylic urethane latexes, styrene-butadiene latexes, acrylonitrile-butadiene latexes, and vinyl acetate latexes.

With respect to the molecular weight of the water-dispersible latex, it is preferably 3,000 to 100,000 and particularly preferably about 5,000 to 100,000 on the basis of the number average molecular weight. With the use of a water-dispersible latex having excessively small molecular weight, the dynamic strength of a base coat layer may become insufficient, and with the use of a water-dispersible latex having excessively large molecular weight, this may disadvantageous from the aspects of production applicability such as dispersion stability and viscosity.

Among the water-dispersible latexes, at least one selected from acrylic silicone latexes and acrylic styrene latexes is most preferably used from the perspective that the first layer of the present invention is highly effective in ink solvent permeability and preventing the occurrence of cockling, and has both economic efficiency and production applicability.

### <Second Layer Forming Step>

The second layer forming step is not particularly limited, and may be suitably selected in accordance with the intended use, provided that a second layer is formed on the first layer. However, when a shearing rate D(=S/(t×60×10⁻⁶)) of a coating solution for forming a second layer, which is defined depending on a coating rate S (m/min) and a film thickness t (μm) of a coated layer, is within the range of from 10³ (s⁻¹) to 10⁶ (s⁻¹), it is preferable that the high-shear viscosity be from 20 mPa·s 150 mPa·s and the coating solution for forming a second layer be applied onto the first layer by a blade coating method.

### <<High-Shear Viscosity>>

The high-shear viscosity of a top coat layer (second layer) coating solution is preferably 30 mPa·s to 150 mPa·s and more preferably 40 mPa·s to 140 mPa·s.

When the high-shear viscosity is lower than 20 mPa·s, the top coat layer coating solution does not infiltrate into the base coat layer, and thus the coated amount cannot be increased by blade coating. When the high-shear viscosity is higher than 150 mPa·s, the fluidity of the top coat layer coating solution is impaired, which is unsuitable for handling.

### <<Blade Coating Method>>

The blade coating method is a coating method in which at the moment a coating solution applied onto a paper support is scraped by a blade, a relatively large shearing stress generates.

### <Other Steps>

Other steps are not particularly limited and may be suitably selected in accordance with the intended use.

### (Inkjet Recording Method)

An inkjet recording method of the present invention includes an ink image forming step, a drying/removing step and further includes other steps suitably selected in accordance with the necessity.

### <Ink Image Forming Step>

The ink image forming step is not particularly limited and may be suitably selected in accordance with the intended use, as long as an image can be formed with ink based on predetermined image data.

### <Drying/Removing Step>

The drying/removing step is not particularly limited and may be suitably selected in accordance with the intended use, as long as an ink solvent in a recording medium having the ink image formed on its surface is removed. In a recording medium according to the present invention, since an ink absorption layer as the second layer has moderate permeability, the drying/removing step is carried out in a state where the ink solvent (water) is present near the surface of the recording medium.

### <Other Steps>

Other steps are not particularly limited and may be suitably selected in according with the intended use. For example, a treatment liquid supplying step, and a thermally fixing step are exemplified.

### —Treatment Liquid Supplying Step—

The treatment liquid supplying step is not particularly limited and may be suitably selected in accordance with the intended use, as long as a treatment liquid containing an acidic material, which will be described hereinbelow, is supplied.

—Thermally Fixing step—

The thermally fixing step is not particularly limited and may be suitably selected in accordance with the intended use, as long as latex particles contained in an ink used in the inkjet recording method is fused and fixed on a recording medium.

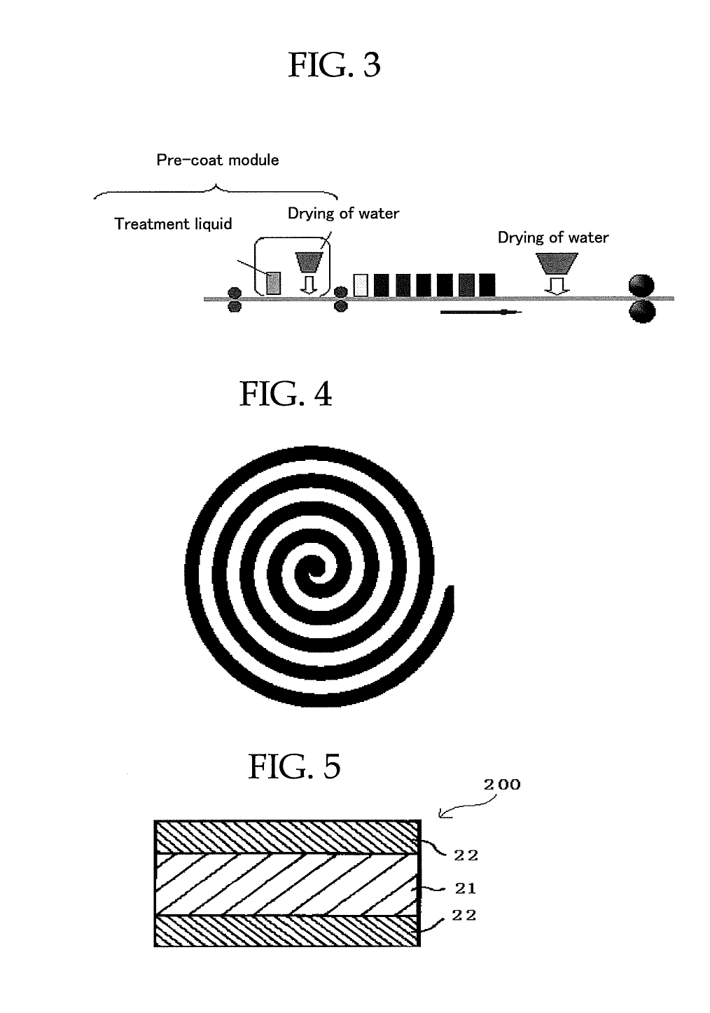

The inkjet recording method is categorized into the following two modes: an inkjet recording mode 1 (FIG. 2) in which an ink image or the like is formed on a recording medium in which a flocculating agent (treatment liquid) is contained in a second layer (ink absorption layer) beforehand; and an inkjet recording mode 2 (FIG. 3) in which a treatment liquid is supplied to a recording medium (pre-coating), and thereafter an ink image or the like is formed.

### —Inkjet Recording Mode 1—

In the inkjet recording mode 1, ink image forming, drying (drying of water, drying by air blasting), and fixing are carried out under the following conditions, for example.

—Ink Image Formation—
Head: full-line head of 1,200 dpi/20 inch width
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

Wind velocity: 8 m/s to 15 m/s
Temperature: 40° C. to 80° C.
Air blasted region: 640 mm (drying time: 1 sec.)

### —Fixing—

Silicone rubber roller (hardness: 50 degrees, nip width: 5 mm)
Temperature of roller: 70° C. to 90° C.
Pressure applied: 0.5 MPa to 2.0 MPa

### —Inkjet Recording Mode 2—

In the inkjet recording mode 2, pre-coating, ink image forming, drying (drying of water, drying by air blasting), and fixing are carried out under the following conditions, for example.

### —Treatment Liquid Head for Pre-Coat Module—

Head: full-line head of 600 dpi/20 inch width
Amount of liquid droplets ejected: two-value recording using 0 pL and 4.0 pL
Drive frequency: 15 kHz (conveyance rate of recording medium: 635 mm/sec)
Pattern of image formation: in an ink image forming step, a pattern is used in which a treatment liquid is previously applied to a region of a recording medium at which an image is to be formed with at least one or more color inks.

### —Drying of Water (Drying by Air Blasting) for Pre-Coat Module—

Wind velocity: 8 m/s to 15 m/s; temperature: 40° C. to 80° C.; air blasted region: 450 mm (drying time: 0.7 sec.)

### —Ink Image Formation—

Head: full-line head of 1,200 dpi/20 inch width
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

Wind velocity: 8 m/s to 15 m/s
Temperature: 40° C. to 80° C.
Air blasted region: 640 mm (drying time: 1 sec.)

### —Fixing—

Silicone rubber roller (hardness: 50 degrees, nip width: 5 mm)
Temperature of roller: 70° C. to 90° C.
Pressure applied: 0.5 MPa to 2.0 MPa

### <Two-Aqueous Liquid Agglomerated Ink>

In the inkjet recording method, a treatment liquid and a two-aqueous liquid agglomerated ink composed of an ink which reacts with the treatment liquid to agglomerate may be used.

### —Treatment Liquid—

As an acidic material that is used for adjusting the pH of the treatment liquid to be acidic, it is possible to use phosphoric acid group, phosphonic acid group, phosphinic acid group, sulfuric acid group, sulfonic acid group, sulfinic acid group and/or carboxylic acid group or salts thereof. More preferably, the acidic material preferably contains a phosphoric acid group, or a carboxylic acid group, and still more preferably, it contains a carboxylic acid group. As a carboxylic acid, compounds having a furan structure, pyrrole structure, pyrroline structure, pyrrolidone structure, pyron structure, thiophene structure, indole structure, pyridine structure, or quinoline structure and further having a carboxyl group as a functional group are exemplified. Specifically, pyrrolidone carboxylic acid, pyron carboxylic acid, pyrrole carboxylic acid, furan carboxylic acid, pyridine carboxylic acid, coumarinic acid, thiophene carboxylic acid, nicotinic acid and/or the derivatives thereof, and/or salts thereof are exemplified. For example, these carboxylic acids are added to the treatment liquid.

Further, the acidic material is preferably pyrrolidone carboxylic acid, pyron carboxylic acid, furan carboxylic acid, coumarinic acid or derivatives thereof or salts thereof. These compounds may be used alone or in combination.

The treatment liquid may contain other additives within the range where effects of the present invention are not impaired. Examples of the other additives include conventionally known additives such as dry inhibitor (humectant), discoloration inhibitor, emulsification stabilizer, permeation promoter, ultraviolet ray absorber, preservative agent, antifungal agent, pH regulator, surface tension adjustor, antifoaming agent, viscosity adjustor, dispersant, dispersion stabilizer, anti-corrosive agent, and chelate agent.

### —Ink—

The ink can be used not only in monochrome image formation but also in full-color image formation. In order to form a full-color image, a magenta-color ink, a cyan-color ink, and a yellow-color ink can be used. In order to control the color tones of these color inks, a black-color ink can be further used. Further, red colors, green colors and blue colors other than the yellow, magenta, cyan-color inks, white ink and so-called characteristic inks in the printing field (e.g. colorless ink) can be used. For the ink, for example, inks containing latex particles, an organic pigment, a dispersant and a water-soluble organic solvent and further containing other additives in accordance with the necessity are exemplified.

### —Latex Particles—

Examples of the latex particles include polymers of compounds composed of any of a nonionic monomer, an anionic monomer or a cationic monomer.

The nonionic monomer means a monomer compound having no dissociable functional groups. The monomer compound represents a single compound or a compound polymerizable with another compound in the broad sense. The monomer compound is preferably a monomer compound having an unsaturated double bond.

The anionic monomer means a monomer compound containing an anionic group that can have negative charges. The anionic group may be any anionic group, provided that it has negative charges, however, it is preferably a phosphoric acid group, a phosphonic acid group, a phosphinic acid group, a sulfuric acid group, a sulfonic acid group, a sulfinic acid group or a carboxylic acid group. It is more preferably a phosphoric acid group or a carboxylic acid group. Still more preferably, it is a carboxylic acid group.

The cationic monomer means a monomer containing a cationic group that can have positive charges. The cationic group may be any cationic group, provided that it has positive charges, however, it is preferably an organic cationic substituent, more preferably a cationic group of nitrogen or phosphorous, and still more preferably it is a pyridinium cation or an ammonium cation.

### —Organic Pigment—

As organic pigments for orange color or yellow color, the following are exemplified: C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, C.I. Pigment Yellow 138, C.I. Pigment Yellow 151, C.I. Pigment Yellow 155, C.I. Pigment Yellow 180, and C.I. Pigment Yellow 185.

As organic pigments for magenta color or red color, the following are exemplified: C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, and C.I. Pigment Violet 19.

As organic pigments for green color or cyan color, the following are exemplified: C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Breen 7, and siloxane-crosslinked aluminum phthalocyanine described in U.S. Pat. No. 4,311,775.

As organic pigments for black color, the following are exemplified: C.I. Pigment Black 1, C.I. Pigment Black 6, and C.I. Pigment Black 7.

Further, from the standpoint of transparency and color reproductivity, the average particle diameter of the organic pigment is preferably smaller, but from the standpoint of resistance to light, the average particle diameter of the organic pigment is preferably larger. As an average particle diameter satisfying both these properties, it is preferably 10 nm to 200 nm, more preferably 10 nm to 150 nm, and still more preferably 10 nm to 100 nm. The particle size distribution of the organic pigment is not particularly limited, and it may be an organic pigment having a wide particle size distribution or an organic pigment having a monodisperse particle size distribution. Further, a mixture of two or more organic pigments having a monodisperse particle size distribution may be used.

The additive amount of the organic pigment is preferably 1% by mass to 25% by mass, more preferably 2% by mass to 20% by mass, and still more preferably 5% by mass to 20% by mass, and particularly preferably 5% by mass to 15% by mass relative to the total mass of the ink.

### —Dispersant—

With respect to a dispersant for the organic pigment, any one of a polymer dispersant and a low-molecular weight surfactant type dispersant may be used. Further, the polymer dispersant may be any of a water-dispersible dispersant or a non-aqueous dispersant.

The low-molecular weight surfactant type dispersant is added for the purpose of stably dispersing the organic pigment in an aqueous medium while keeping the ink at a low viscosity. The low-molecular weight dispersant is a dispersant having a low-molecular weight of 2,000 or less. The molecular weight of the low-molecular weight dispersant is preferably 100 to 2,000 and more preferably 200 to 2,000.

The low-molecular weight dispersant has a structure including a hydrophilic group and a hydrophobic group.

Further, for each of the hydrophilic group and the hydrophobic group, one or more groups may be contained in one molecule thereof. The low-molecular weight dispersant may also have various hydrophilic groups and hydrophobic groups and may also have appropriate linking groups for linking hydrophilic groups and hydrophobic groups.

The hydrophilic group is an anionic hydrophilic group, a cationic hydrophilic group, or a betaine hydrophilic group which is composed of a combination of an anionic hydrophilic group and a cationic hydrophilic group.

The anionic group may be any of anionic groups having negative charges, however, it is preferably a phosphoric acid group, phosphonic acid group, phosphinic acid group, sulfuric acid group, sulfonic acid group, sulfinic acid group or carboxylic acid group. It is more preferably a phosphoric acid group or a carboxylic acid group, and still more preferably a carboxylic acid.

The cationic group may be any of cationic groups having positive charges, however, it is preferably an organic cationic substituent, more preferably a cationic group of nitrogen or phosphorous, and still more preferably it is a pyridinium cation or an ammonium cation.

As the nonionic group, polyethylene oxide, polyglycerin, and part of sugar components are exemplified.

The hydrophilic group is preferably an anionic group. The anionic group is preferably a phosphoric acid group, phosphonic acid group, phosphinic acid group, sulfuric acid group, sulfonic acid group, sulfinic acid group or carboxylic acid group.

It is more preferably a phosphoric acid group or a carboxylic acid group, and still more preferably a carboxylic acid group.

When the low-molecular weight dispersant has an anionic hydrophilic group, it is preferable that the pKa be 3 or higher, from the perspective of promoting an agglomeration reaction by making it contact with the acidic treatment liquid. In the present invention, the pKa of the low-molecular weight dispersant is a value that is experimentally determined from a titration curve which is obtained by titration of a solution liquid, in which 1 mmol/L of a low-molecular weight dispersant is dissolved in a tetrahydrofuran-water (3:2=V/V) solution, with an acid or alkaline aqueous solution. Theoretically, when a low-molecular weight dispersant having a pKa value of 3 or higher becomes contact with a treatment liquid having a pH of 3 or so, 50% or more of the anionic group becomes in a non-dissociated state. Thus, the water solubility of the low-molecular weight dispersant is significantly reduced to cause an agglomeration reaction. In other words, the agglomeration reactivity is improved. From this viewpoint as well, it is preferable that the low-molecular weight dispersant have a carboxylic acid group as an anionic group.

The hydrophobic group preferably has a hydrocarbon-based, fluorocarbon-based, or silicone-based structure and particularly preferably a hydrocarbon-based structure. The structure of the hydrophobic group may be a straight chain structure or a branched structure. The structure of the hydrophobic group may be a one-chain structure or a structure having one or more chains. When the hydrophobic group has a structure with 2 or more chains, it may have a plurality of hydrophobic groups.

The hydrophobic group is preferably a hydrocarbon group having 2 to 24 carbon atoms, more preferably a hydrocarbon group having 4 to 24 carbon atoms, and still more preferably a hydrocarbon group having 6 to 20 carbon atoms.

Among polymer dispersants, as a water-soluble dispersant, a hydrophilic polymeric compound can be used. Examples of natural hydrophilic polymeric compounds include vegetable polymers such as gum arabic, trangacanth gum, guar gum, locust beam gum, arabino galactan, pectin, and quince seed starch; seaweed polymers such as alginic acid, carrageenen, and agar; animal polymers such as gelatin, casein, albumin, and collagen; and microbe polymers such as xanthan gum, and dextran.

Examples of hydrophilic polymer compounds, in which natural products are modified with raw material, include cellulose polymers such as methyl cellulose, ethyl cellulose, hydroxyethyl cellulose, hydroxypropyl cellulose, and carboxymethyl cellulose; starch polymers such as sodium glycolate starch, and sodium phosphoester starch; and seaweed polymers such as alginate sodium, and alginate propylene glycolate.

Examples of water-soluble polymer compounds include vinyl polymers such as polyvinyl alcohol, polyvinyl pyrrolidone, polyvinyl methylether; non-crosslinked polyacrylamides, polyacrylic acids, or alkali metal salts thereof, and water-soluble styrene acrylic resins; polymeric compounds having salts of cationic functional groups at side chains thereof such as water-soluble styrene maleic acid resins, water-soluble vinylnaphthalene acrylic resins, water-soluble vinylnaphthalene maleic resins, polyvinyl pyrrolidone, polyvinyl alcohol, alkali metal salts of β-naphthalene sulfonate formalin condensates, tetraammonium, and amino groups; and natural polymer compounds such as shellac.

Of these, a compound into which a carboxyl group introduced, such as a compound composed of a copolymer of a homopolymer such as acrylic acid, methacrylic acid, or styrene acrylic acid and a monomer having other hydrophilic groups is particularly suitable for the polymer dispersant.

Among polymer dispersants, as a non-aqueous dispersant, a polymer having both hydrophobic parts and hydrophilic parts can be used. Examples of such a polymer include styrene-(meth)acrylic acid ester copolymers, styrene-(meth)acrylic acid-(meth)acrylic aid ester copolymers, (meth)acrylic acid ester-(meth)acrylic acid copolymers, polyethylene glycol(meth)acrylate-(meth)acrylic acid copolymers, vinyl acetate-maleic acid copolymers, and styrene-maleic acid copolymers.

The mass average molecular weight of the dispersant is preferably 3,000 to 100,000, more preferably 5,000 to 50,000, still more preferably 5,000 to 40,000, and particularly preferably 10,000 to 40,000.

The mass ratio of the organic pigment to the dispersant is preferably within the range of 1:0.06 to 1:3, more preferably within the range of 1:0.125 to 1:2, and still more preferably within the range of 1:0.125 to 1:1.5.

### —Water-Soluble Organic Solvent—

The water-soluble organic solvent is used for the purpose of preventing desiccation and promoting humectation. The dry inhibitor is preferably used for an ink ejection port of a nozzle used based on an inkjet recording method and prevents nozzle clogging due to desiccation of inkjet ink.

The dry inhibitor is preferably a water-soluble organic solvent having a vapor pressure lower than that of water. Specific examples of such a dry inhibitor include polyhydric alcohols typified by ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin, and trimethylol propane; lower alkyl ethers of polyhydric alcohols such as ethylene glycol monomethyl (or ethyl)ether, diethyleneglycolmonomethyl (or ethyl)ether, and triethyleneglycolmonoethyl (or butyl)ether; heterocyclic compounds such as 2-pyrrolidone, N-methyl-2-pyrrolidone, 1,3-dimethyl-2-imidazolidinone, and N-ethyl morpholine; sulfur-containing compounds such as sulfolane, dimethylsulfoxide, and 3-sulfolane; polyfunctional compounds such as diacetone alcohol, diethanol amine; and urea derivatives. Of these, polyhydric alcohols such as glycerin and diethylene glycol are suitable for the dry inhibitor. These dry inhibitors may be used alone or in combination. It is preferable that 10% by mass to 50% by mass of the dry inhibitor be contained in the ink.

The permeation promoter is preferably used for the purpose of making ink sufficiently infiltrate recording media (printing sheets). Specifically, as the permeation promoter, alcohols such as ethanol, isopropanol, butanol, di(tri)ethylene glycol monobutylether, and 1,2-hexandiol: lauryl sodium sulfate, sodium oleate, and nonionic surfactants are preferable. When these permeation promoters are contained at 5% by mass to 30% by mass in an ink composition, sufficient effect can be exhibited. Further, it is preferable that the permeation promoter be used within the range where it does not cause print bleeding, and paper through (print through).

Further, the water-soluble organic solvent is used for the purpose of adjusting the viscosity of the ink, besides the above-mentioned purposes. Specific examples of the water-soluble organic solvent that can be used for adjusting the viscosity include alcohols (such as methanol, ethanol, propanol, isopropanol, butanol, isobutanol, sec-butanol, t-butanol, pentanol, hexanol, cyclohexanol, and benzyl alcohol); polyhydric alcohols (such as ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thioglycol); glycol derivatives (such as ethylene glycol monomethylether, ethylene glycol monoethylether, ethylene glycol monobutylether, diethylene glycol monomethylether, diethylene glycol monobutylether, propylene glycol monomethylether, propylene glycol monobutylether, dipropylene glycol monomethylether, triethylene glycol monomethylether, ethylene glycol diacetate, ethylene glycol monomethylether acetate, triethylene glycol monomethylether, triethylene glycol monoethylether, and ethylene glycol monophenylether), amines (such as ethanolamine, diethanolamine, N-methyldethanolamine, N-ethyldiethanolamine, morpholino, N-ethylmorpholino, ethylenediamine, diethylenetriamine, triethylenetetramine, polyethyleneimine, and tetramethylpropylenedianine); and other polar solvents (such as formamide, N,N-dimethylformamide, N,N-dimethylacetoamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinon, acetonitrile, and acetone). These water-soluble organic solvents may be used alone or in combination.

### —Other Additives—

Examples of the other additives include conventionally know additives such as dry inhibitor (humectant), discoloration inhibitor, emulsification stabilizer, permeation promoter, ultraviolet ray absorber, preservative agent, antifungal agent, pH regulator, surface tension adjustor, antifoaming agent, viscosity adjustor, dispersant, dispersion stabilizer, anti-corrosive agent, and chelate agent. In the case of a water-soluble ink, these various additives are directly added to the ink. When an oil-soluble dye is used in the form of a dispersion, firstly a dye dispersion is prepared and then various additives are added to the dye dispersion, in general, however, the oil-soluble dye may be added in an oil phase or an aqueous phase at the time of preparation of the dye dispersion.

The ultraviolet ray absorber is used for the purpose of improving the storage stability of images. Examples of the ultraviolet ray absorber for use in the present invention include benzotriazole compounds described in Japanese Patent Application Laid-Open (JP-A) Nos. 58-185677, 61-190537, 02-782, 05-197075, and 09-34057; benzophenone compounds described in Japanese Patent Application Laid-Open (JP-A) Nos. 46-2784, 05-194483, and U.S. Pat. No. 3,214,463; cinnamic acid compounds described in Japanese Patent Application Publication (JP-B) No. 48-30492, 56-21141, Japanese Patent Application (JP-A) No. 10-88106; triazine compounds described in Japanese Patent Application Laid-Open (JP-A) Nos. 04-298503, 08-53427, 08-239368, 10-182621, and 08-501291; compounds described in Research Disclosure No. 24239, compounds that absorb ultraviolet rays and emit fluorescence, typified by stilbene compounds and benzoxazole compounds, so-called fluorescent whitening agents.

The discoloration inhibitor is used for the purpose of improving storage stability of images. As the discoloration inhibitor, various organic type and metal complex type discoloration inhibitors can be used. Examples of the organic discoloration inhibitors include hydroquinones, alkoxyphenols, dialkoxyphenols, phenols, anilines, amines, indans, chromanes, alkoxyanilines, and heterocyclic compounds. Examples of the metal complex discoloration inhibitors include nickel complex, and zinc complex. More specific examples of the discoloration inhibitors for use in the present invention include compounds described in Patent documents cited at paragraphs I-J of the VII of Research Disclosure No. 17643, No. 15162, on the left side column at page 650 of No. 18716, at page 527 of No. 36544, at page 872 of No. 307105, and No. 15162, and typical compounds represented by the general formula and compounds included in the compound examples described at pp 127-137 of Japanese Patent Application Laid-Open (JP-A) No. 62-215272.

Examples of the antifungal agent include sodium dehydroacetate, sodium benzoate, sodium pyridinethion-1-oxide, p-hydroxybenzoate ethyl ester, 1,2-benzisothiazoline-3-one, and salts thereof. It is preferable that 0.02% by mass to 1.00% by mass of these antifungal agents be used in the ink.

As the pH regulator, a neutralizer (organic base, inorganic alkali) can be used. The pH regulator is preferably added so that the inkjet ink has a pH of 6 to 10 and more preferably added so that the ink has a pH of 7 to 10, for the purpose of improving the storage stability of the inkjet ink.

Examples of the surface tension adjustor include nonionic surfactants, cationic surfactants, anionic surfactants, and betaine surfactants.

With respect to the additive amount of the surface tension adjustor, it is preferably such an additive amount that the surface tension of the ink can be adjusted within the range of 20 mN/m to 60 mN/m, more preferably within the range of 20 mN/m to 45 mN/m, and still more preferably within the range of 25 mN/m to 40 mN/m.

Specific preferred examples of the hydrocarbon type surfactant include anionic surfactants such as fatty acid salts, alkyl sulfate salts, alkylbenzene sulfonate, alkylnaphthalene sulfonate, dialkylsulfosuccinate, alkyl phosphate salts, naphthalene sulfonate formalin condensates, polyoxyethylene alkyl sulfate salts; and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkylamine, glycerin fatty acid ester, and oxyethylene-oxypropylene copolymers. Further, SURFYNOLS (available from Air Products & Chemicals Co.) which is an acetylene type polyoxyethylene oxide surfactant can be preferably used as well. Further, an amineoxide type amphoteric surfactant such as N,N-dimethyl-N-alkylamineoxide is also preferable.

Furthermore, surfactants described at pp 37-38 of Japanese Patent Application Laid-Open (JP-A) No. 59-157636 and surfactants exemplified in Research Disclosure No. 308119 (1989) can also be used.

Further, by using any of fluorine (alkyl fluoride type) surfactants and silicone surfactants as described in Japanese Patent Application Laid-Open (JP-A) Nos. 2003-322926, 2004-325707, and 2004-309806, the abrasion resistance can be improved.

Further, these surface tension adjustors may be used as antifoaming agents, and chelate agents typified by a fluorine compound, a silicone compound, and EDTA can be used as well.

### EXAMPLES

Hereinafter, the present invention will be further described in detail with reference to Examples of the present invention, however, the present invention is not limited to the disclosed Examples. On the contrary, the present invention is intended to cover various modifications and equivalent arrangements included within the spirit and scope of the appended claims.

It should be noted that the units represented by “part”, “parts”, and “%” hereinbelow are construed on the basis of “mass”, namely, as “part by mass”, “parts by mass”, or “% by mass”, unless otherwise noted; and the term “polymerization degree” represents “average polymerization degree”.

### Example 1

### Preparation of First Layer (Base Coat Layer) Coating Solution

### (1) Preparation of Acetoacetyl-Modified Polyvinyl Alcohol

Into 88 parts of water, 12 parts of acetoacetyl-modified polyvinyl alcohol (saponification degree: 95% to 97%; polymerization degree: 1,000; product name: GOHSEFIMER Z-210, manufactured by Nippon Synthetic Chemical Industry Co., Ltd.) were added and dissolved at 90° C. or higher with stirring.

### (2) Water-Swellable Mica Dispersion Liquid (Having Aspect Ratio of 1,000 and an Average Particle Diameter of 2.0 μm; Product Name: SOMASHIFU MEB-3 (8% Solution) Manufactured by Corp Chemical Co., Ltd.)

(3) Solution Containing 1.66% of Ethyleneoxide Surfactant (Dissolved in Methanol) (Product Name: EMALEX 710 Manufactured by Japan Emulsion Co. Ltd.)

Into 100 parts of the 12% acetoacetyl-modified polyvinyl alcohol solution (1), 58 parts of water were added, sufficiently stirred and mixed, 18 parts of the 8% water-swellable mica dispersion liquid (2) were added thereto and sufficiently stirred and mixed, and 3 parts of the 1.66% ethyleneoxide surfactant solution (3) were added thereto. The liquid temperature of the obtained mixture liquid was maintained at 30° C. to 35° C., and a base coat layer coating solution was thus obtained.

### <Preparation of Second Layer (Top Coat Layer) Coating Solution>

Sixty parts of heavy calcium carbonate (product name: ESCALON #2000, manufactured by Sankyo Seifun Co., Ltd.), 20 parts of kaolin (product name: MIRAGLOSS, manufactured by Engelhard Corporation: U.S.), 20 parts of titanium oxide (TIPAQUE R-780, manufactured by ISHIHARA INDUSTRY CO., LTD.), and 0.5 parts of a liquid containing 43% of sodium polyacrylate (product name: ARON T-50, manufactured by TOAGOSEI CO., LTD.) were mixed to prepare a mixture, and the mixture was dispersed using an NBK-2 manufactured by Nippon Seiki Co., Ltd. Into the dispersion liquid, 11 parts of styrene-butadiene copolymer latex having an average particle diameter of 95 nm (product name: SMARTEX PA2323, manufactured by Nippon A&L Inc.), 3 parts by mass of starch oxide (product name: ACE B, manufactured by Oji Cornstarch Co., Ltd.) and 1 part of lubricant (product name: SN COAT 231SP, manufactured by Sunnopco Co. Ltd) were added, and a top coat coating solution having a final solid content concentration of 65% was thus prepared.

### <Formation of First Layer (Base Coat Layer)>

On both surfaces of high-quality paper having a basis weight of 81.4 g/m² (product name: SHIRAOI, manufactured by Nippon Paper Industries Co., Ltd.), the obtained base coat layer coating solution was applied using a bar coater so that the coated amount per one surface became 8.0 g/m², and each of the coated surfaces was dried at 50° C. for 3 minutes, thereby forming a base coat layer. The base coat layers formed at this stage respectively had a thickness of 8.1 μm per one surface.

### <Formation of Second Layer (Top Coat Layer)>

On both surfaces of the high-quality paper with the base coat layers provided, the prepared top coat layer coating solution was applied using a high-speed leaf blade coater (product name: PM-9040M, SMT Co., Ltd.) so that the dry mass per one surface became 10 g/m², and each of the coated surfaces was dried at a temperature of 150° C. and a wind velocity of 20 m/sec for 3 seconds, thereby forming a top coat layer. The top coat layer formed at this stage had a thickness of 11.2 μm per one surface.

### <Evaluation of Recording Medium>

On the recording medium obtained in Example 1, “Cobb water absorption test of high-quality paper with base coat layer formed on both surfaces thereof”, “water absorption test of top coat layer”, “curl property test”, “ink droplet jetting test”, “test of cockling resistance immediately after image formation” and “test of uniformity of image density” were carried out. Table 1-1 and Table 1-2 show the test results.

—Cobb Water Absorption Test of High-Quality Paper with Base Coat Layer Formed on Both Surfaces Thereof—

(1) Cobb absorption degree (amount of water permeated (g/m²) when being contact with 20° C. water for 15 sec.) of the coated surface of the high-quality paper with the base coat layer formed on both surfaces thereof was measured according to the water absorption test method defined in JIS P8140.

(2) Cobb absorption degree (amount of water permeated (g/m²) when being contact with 20° C. water for 2 min.) of the coated surface of the high-quality paper with the base coat layer formed on both surfaces thereof was measured according to the water absorption test method defined in JIS P8140.

(3) Cobb value (amount of diethylene glycol permeated (g/m²) when being contact with 20° C. diethylene glycol for 2 min.) of the coated surface of the high-quality paper with the base coat layer formed on both surfaces thereof was measured according to the water absorption test method defined in JIS P8140.

### —Water Absorption Test of Top Coat Layer—

The water absorption test of the top coat layer was measured based on the Bristow's method as follows.

(1) A top coat layer sample which was cut in A6 size was set on a measurement disc, a head filled with a test liquid was made contact with the surface of the sample, and the sample surface was automatically scanned along a scanning line as shown in FIG. 4 (from an inside toward an outside of the sample) to thereby measure the liquid absorption property of the sample. A relation between a contact time and an amount of liquid absorbed (amount of water absorbed) was obtained by changing step-by-step the rotation rate of the measurement disc (the contact time between paper and ink). Table 1 shows the water absorbed amount after a contact time of 0.5 sec.

(2) The amount of water absorbed was determined in a similar manner to the method described above (1), except that water used in (1) was changed to pure water containing 30% by mass of diethylene glycol. Table 1 shows the amount of liquid absorbed after a contact time of 0.9 sec.

### —High-Shear Viscosity Measurement Method of Top Coat Layer Coating Solution—

The high-shear viscosity of the top coat layer coating solution was measured as follows. Firstly, with the use of a HERCULES high-shear viscometer (HERCULES HIGH-SHEAR VISCOMETER, manufactured by Kumagai Riki Kogyo Co., Ltd.), an appropriate amount of the top coat layer coating solution was poured in a cup of 40 mm in inner diameter and 80.5 mm in effective depth, the sweep time was set to 10 sec. and the maximum number of rotations was set to 8,800 rpm, and a flow curve ([shearing rate (rpm)]−[shear stress (torque) curve] was determined using a bob F (rotator) having a diameter of 39.8 mm and an effective length of 25 mm (clearance with respect to the cup: 0.1 mm), and from the flow curve, an appearance viscosity of the top coat layer coating solution was determined.

### —Evaluation of Glossiness of White Paper—

The glossiness of a white background of the recording medium was measured using an angle variable glossiness meter (product name: UGV-5D, manufactured by Suga Tester Co., Ltd.), in which the incident angle was set at 750 and the light receiving angle was set at 750, according to JIS Z8741 (1997). The glossiness of the white background was evaluated based on the following criteria.

### [Evaluation Criteria]

AA: The glossiness was 50% or higher.

BB: The glossiness was 35% or higher to lower than 50%.

CC: The glossiness was 20% or higher to lower than 35%.

DD: The glossiness was lower than 20%.

### —Curl Property Test—

Onto the recording medium with the second layer (top coat layer) formed on both surfaces thereof, water was applied so that the amount of water absorbed to a test specimen of 50 mm×5 mm in size became 10 g/m² in respective directions of MD and CD of the specimen. According to the measurement method of a curl curvature defined in No. 15-2:2000 of the Paper Pulp test method (Japan TAPPI), the specimen was left intact under the conditions of 23° C. and 50% RH for 8 hours, and the curl degree of the specimen was measured and evaluated based on the following criteria.

### [Evaluation Criteria]

AAA: The curl degree was lower than 5.

AA: The curl degree was 5 or higher to lower than 10.

BB: The curl degree was 10 or higher to lower than 20.

CC: The curl degree was 20 or higher to lower than 30.

DD: The curl degree was 30 or higher.

—Evaluation of Cockling Resistance Immediately after Image Formation—

On a recording medium in a postcard size with the top coat layer formed on both surfaces thereof, a solid image of 100% monochrome and 2 cm×2 cm in size was printed at a center portion of the postcard-size recording medium, and a maximum height of wavy portions that were caused immediately after the image formation was measured using a laser displacement meter. The measurement results were evaluated based on the following criteria.

### [Evaluation Criteria]

AA: The maximum height was 1 mm or higher to less than 2 mm.

BB: The maximum height was 2 mm or higher to less than 3 mm.

CC: The maximum height was 3 mm or higher.

### —Evaluation of Image Density Uniformity—

The monochrome 100% solid image which was formed on the postcard size recording medium for evaluating the cockling resistance was visually checked and evaluated in accordance with the following criteria.

### [Evaluation Criteria]

AA: The density corresponding to the solid image area was uniform, and no white void (ink void) and ink spot was observed.

BB: A small number of white voids (ink voids) and ink spots were observed, but there is no problem in practical use.

CC: A large number of white voids (ink voids) and ink spots were observed, but the practical usability was low.

DD: A substantial number of white voids (ink voids) and ink spots were observed, but the practical usability was significantly low.

### —Ink Droplet Jetting Test—

### <Preparation of Ink>

### (1) Preparation of Cyan Pigment Ink C

### —Preparation of Pigment Dispersion—

In a vessel, 10 g of CYANINE BLUE A-22 (C.I. PB 15:3) manufactured by Dainichiseika Color & Chemicals Mfg. Co., Ltd., 10.0 g of a low-molecular weight dispersant 2-1, 4.0 g of glycerin and 26 g of ion exchange water were stirred and mixed to prepare a dispersion liquid. Next, the dispersion liquid was intermittently irradiated (irradiated: 0.5 sec. and paused: 1.0 sec.) with a supersonic wave for 2 hours using supersonic irradiation equipment (VIBRA-CELL VC-750, manufactured by SONICS; taper micro chip: φ5 mm, amplitude: 30%) so as to further disperse the pigment, thereby preparing 20% by mass of a pigment dispersion liquid. Note that the low-molecular weight dispersant 2-1 is represented by the following Chemical Formula.

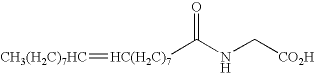

Separately from the pigment dispersion liquid, the following compound was weighed, stirred and mixed to prepare a mixture liquid I.

| | |
|---|---|
| glycerin | 5.0 g |
| diethylene glycol | 10.0 g |
| OLFIN E1010 (manufactured by Nisshin Kagaku Co., Ltd.) | 1.0 g |
| ion exchange water | 11.0 g |

This mixture liquid I was slowly delivered by drops in 23.0 g of a stirred dispersion liquid containing 44% of SBR(polymer fine particle: 3% by mass of acrylic acid, glass transition temperature (Tg) of 30° C.), stirred and mixed to prepare a mixture liquid II.

The mixture liquid II was slowly delivered by drops in 20% of the pigment dispersion liquid, stirred and mixed to prepare 100 g of a cyan color pigment ink C (cyan ink). The pH of the pigment ink C thus prepared was measured using a pH meter WM-50EG manufactured by Toa Denpa Kogyo K.K. The pigment ink C had a pH of 8.5.

### (2) Preparation of Magenta Pigment Ink M

A magenta pigment ink M (magenta color ink) was prepared in a similar manner to the Preparation of Pigment Ink C, except that CROMOPHTAL JET MAGENTA DMQ (PR-122) available from Chiba Specialty Chemicals K.K. was used in place of the pigment used in the formulation of Preparation of Pigment Ink C. The pH of the pigment ink M thus prepared was measured using a pH meter WM-50EG manufactured by Toa Denpa Kogyo K.K. The pigment ink M had a pH of 8.5.

### (3) Preparation of Yellow Pigment Ink Y

A yellow pigment ink Y (yellow color ink) was prepared in a similar manner to the Preparation of Pigment Ink C, except that IRGALITE YELLOW GS (C.I. PY74) available from Chiba Specialty Chemicals K.K. was used in place of the pigment used in the formulation of Preparation of Pigment Ink C. The pH of the pigment ink Y thus prepared was measured using a pH meter WM-50EG manufactured by Toa Denpa Kogyo K.K. The pigment ink Y had a pH of 8.5.

### (4) Preparation of Black Pigment Ink K

A black pigment ink K (black color ink) was prepared in a similar manner to the Preparation of Pigment Ink C, except that CAB-O-JET TM_{—}200 (carbon black) available from CABOT Corp. was used in place of the pigment used in the formulation of Preparation of Pigment Ink C. The pH of the pigment ink K thus prepared was measured using a pH meter WM-50EG manufactured by Toa Denpa Kogyo K.K. The pigment ink K had a pH of 8.5.

### <Preparation of Treatment Liquid>

The following materials were mixed to prepare a treatment liquid:

| | |
|---|---|
| phosphoric acid | 10 g |
| glycerin | 20 g |
| diethylene glycol | 10 g |
| OLFIN E1010 (manufactured by Nisshin Kagaku Co., Ltd.) | 1 g |
| ion exchange water | 59 g |

The pH of the first treatment liquid thus prepared was measured using a pH meter WM-50EG. The first treatment liquid had a pH of 1.0.

### <Ink Droplet Jetting Mode>

An image was formed according to a four-color-single pass printing mode using an image forming apparatus as illustrated in FIG. 3 through the use of the cyan pigment ink C, magenta pigment ink M, yellow pigment ink Y, black pigment ink K and treatment liquid under the following conditions.

### —Treatment Liquid Head for Pre-Coat Module—

Head: piezo full-line head of 600 dpi/20 inch width
Amount of liquid droplets ejected: two-value recording using 0 pL and 4.0 pL
Drive frequency: 15 kHz (conveyance rate of recording medium: 635 mm/sec)
Pattern of image formation: in an ink image forming step, a pattern was used in which a treatment liquid was previously applied to a region of a recording medium at which an image was to be formed with at least one or more color inks.

### —Drying of Water (Drying by Air Blasting) for Pre-Coat Module—

Wind velocity: 15 m/s
Temperature: The recording medium was heated from its back surface thereof using a contact type flat heater such that the surface temperature of the recording medium became 60° C.
Air blasted region: 450 mm (drying time: 0.7 sec.)

### —Ink Image Formation—

Head: piezo full-line head of 1,200 dpi/20 inch width arranged for each of four colors
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

Wind velocity: 15 m/s
Temperature: 60° C.
Air blasted region: 640 mm (drying time: 1 sec.)

### —Fixing—

Silicone rubber roller (hardness: 50 degrees, nip width: 5 mm)
Temperature of roller: 90° C.
Pressure applied: 0.8 MPa

### <Evaluation Method>

A gray scale image and a character image (letter image) formed for evaluation were visually checked and evaluated according to the following criteria.

### [Evaluation Criteria]

AA: No image bleeding and inter-color mixing of neighboring colors was observed, and a Kanji letter with densely packed linespacing, [symbol] , in 4 pt could be resolved.

BB: No image bleeding and inter-color mixing of neighboring colors was observed, and a Kanji letter with densely packed linespacing, [symbol] , in 5 pt could be resolved.

CC: A large number of image bleeding and inter-color mixing of neighboring colors were observed, and the practical usability of the recording medium was low.

DD: A substantial amount of image bleeding and inter-color mixing of neighboring colors were observed, and the practical usability of the recording medium was significantly low.

### Example 2

A recording medium was prepared in a same manner as in Example 1, except that in the preparation of a base coat layer coating solution, polyvinyl alcohol (saponification degree: 98.5%, polymerization degree: 1,700, product name: PVA-117, manufactured by KURARAY Co., Ltd.) was used in place of the acetoacetyl-modified polyvinyl alcohol (saponification degree: 95% to 97%, polymerization degree: 1,000, product name: GOHSEFIMER Z-210, manufactured by Nippon Synthetic Chemical Industry Co., Ltd.); and in the formation of a top coat layer, the coated amount of the top coat layer coating solution per one surface was changed from 11.2 g/m² to 10.8 g/m². The base coat layers formed at this stage respectively had a thickness of 8.0 μm, and the top coat layers formed at this stage respectively had a thickness of 11.0 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test (evaluated in the same manner as described in Example 1)”, “test of cockling resistance immediately after image formation” and “test of uniformity of image density” were carried out. Table 1-1 and Table 1-2 show the test results.

### Example 3

A recording medium was prepared in a same manner as in Example 1, except that into the base coat layer coating solution of Example 1, 12.0 parts of an aqueous solution containing 4% of 2-ethylenesulfonyl-N-[2-(2-ethylenesulfonyl-acetylamino)-ethyl]-acetamide as a film hardener was further added to obtain a 7.3% base coat layer coating solution; in the formation of a base coat layer, the coated amount of the base coat layer coating solution per one surface was changed from 8.0 g/m² to 5.0 g/m²; and in the formation of a top coat layer, the coated amount of the top coat layer coating solution was changed from 11.2 g/m² to 10.1 g/m². The base coat layers formed at this stage respectively had a thickness of 4.8 μm, and the top coat layers formed at this stage respectively had a thickness of 10.1 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 4

A recording medium was prepared in a same manner as in Example 3, except that in the preparation of a base coat layer coating solution, 3.0 parts of the aqueous solution containing 4% of 2-ethylenesulfonyl-N-[2-(2-ethylenesulfonyl-acetylamino)-ethyl]-acetamide as a film hardener was changed to 24.0 parts of an aqueous solution containing 50% of 2,3-dihydroxy-5-methyl-1,4-dioxane. The base coat layers formed at this stage respectively had a thickness of 3.5 μm, and the top coat layers formed at this stage respectively had a thickness of 12.3 μm. Further, similarly to Example 3, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 5

A recording medium was prepared in a same manner as in Example 3, except that in the preparation of a base coat layer coating solution, 3.0 parts of the aqueous solution containing 4% of 2-ethylenesulfonyl-N-[2-(2-ethylenesulfonyl-acetylamino)-ethyl]-acetamide as a film hardener was changed to 15.0 parts of an aqueous solution containing 40% of glyoxal. The base coat layers formed at this stage respectively had a thickness of 5.2 μm, and the top coat layers formed at this stage respectively had a thickness of 9.9 μm. Further, similarly to Example 3, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 6

A recording medium was prepared in a same manner as in Example 1, except that the “preparation of base coat layer coating solution” and “formation of base coat layer” were respectively changed as follows; the coated amount of the base coat layer coating solution per one surface was changed from 8.0 g/m² to 10.0 g/m²; and the recording medium prepared was subjected to soft calender treatment. The base coat layers formed at this stage respectively had a thickness of 9.7 μm, and the top coat layers formed at this stage respectively had a thickness of 9.0 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### <Preparation of Base Coat Layer Coating Solution>

One hundred parts of titanium dioxide (product name: TIPAQUE R-780, manufactured by ISHIHARA INDUSTRY CO., LTD.), 1.2 parts of a liquid containing 25% of sodium salt of a specific polycarboxylic acid type polymer (product name: DEMOL EP, manufactured by Kao Corp.) and 121.7 parts of water were mixed, the mixture was dispersed using a non-bubbling kneader (product name: NBK-2, manufactured by Nippon Seiki Co., Ltd.), and a dispersion liquid containing 45% of titanium dioxide was thus obtained. Next, into 100 parts of an aqueous dispersion liquid containing 35% of acrylic latex (glass transition temperature: 60° C., minimum film forming temperature: 50° C., product name: AQUABRID 4635, manufactured by DAICEL CHEMICAL INDUSTRIES, LTD.), 100 parts of water and 3.9 parts of the obtained dispersion liquid containing 45% of titanium dioxide were added, sufficiently stirred and mixed, and the liquid temperature of the obtained mixture liquid was maintained at 15° C. to 25° C., thereby obtaining a 18.0% base coat layer coating solution.

### <Formation of Base Coat Layer>

On both surfaces of high-quality paper having a basis weight of 81.4 g/m² (product name: SHIRAOI, manufactured by Nippon Paper Industries Co., Ltd.), the obtained base coat layer coating solution was applied using a bar coater so that the coated amount per one surface became 10.0 g/m², and each of the coated surfaces was dried at 50° C. for 3 minutes, thereby forming a base coat layer. Further, the recording medium with the base coat layer formed on both surfaces thereof was subjected to soft calender treatment.

### —Soft Calender Treatment—

The high-quality paper with the base coat layer formed on both surfaces thereof was subjected to soft calender treatment using a soft calender equipped with a pair of rolls composed of a metal roll and a resin roll under the conditions that the surface temperature of the metal roll was 80° C., the nip pressure was 100 kg/cm, and the calendering speed of 100 m/min.

### Example 7

A recording medium was prepared in a same manner as in Example 6, except that in the preparation of a base coat layer coating solution, the aqueous dispersion liquid containing 35% of acrylic latex was changed to an aqueous dispersion liquid containing 35% of acrylic silicone latex (glass transition temperature: 25° C., minimum film forming temperature: 20° C., product name: AQUABRID ASI-91, manufactured by DAICEL CHEMICAL INDUSTRIES, LTD.). The base coat layers formed at this stage respectively had a thickness of 9.9 μm, and the top coat layers formed at this stage respectively had a thickness of 9.3 μm. Further, similarly to Example 6, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 8

A recording medium was prepared in a same manner as in Example 6, except that in the “preparation of base coat layer coating solution” and “formation of base coat layer”, the aqueous dispersion liquid containing 35% of acrylic latex was changed to a 35% acrylic epoxy latex aqueous dispersion liquid (minimum film forming temperature: 40° C., product name: AQUABRID AEA-61, manufactured by DAICEL CHEMICAL INDUSTRIES, LTD.), and the recording medium was not subjected to soft calender treatment. The base coat layers formed at this stage respectively had a thickness of 10.1 μm, and the top coat layers formed at this stage respectively had a thickness of 9.4 μm. Further, similarly to Example 6, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 9

A recording medium was prepared in a same manner as in Example 6, except that in the “preparation of base coat layer coating solution” and “formation of base coat layer”, the aqueous dispersion liquid containing 35% of acrylic latex was changed to an aqueous dispersion liquid containing 35% of acrylic urethane latex (minimum film forming temperature: 0° C., product name: AQUABRID AU-124, manufactured by DAICEL CHEMICAL INDUSTRIES, LTD.), and the recording medium was not subjected to soft calender treatment. The base coat layers formed at this stage respectively had a thickness of 9.5 μm, and the top coat layers formed at this stage respectively had a thickness of 9.3 μm. Further, similarly to Example 6, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 10

A recording medium was prepared in a same manner as in Example 6, except that in the “preparation of base coat layer coating solution” and “formation of base coat layer”, the aqueous dispersion liquid containing 35% of acrylic latex was changed to an aqueous dispersion liquid containing 35% of styrene-butadiene latex (minimum film forming temperature: 0° C., product name: NIPOL LX110, manufactured by Nippon Zeon Company Limited), and the recording medium was not subjected to soft calender treatment. The base coat layers formed at this stage respectively had a thickness of 9.4 μm, and the top coat layers formed at this stage respectively had a thickness of 9.5 μm.

Further, similarly to Example 6, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 11

A recording medium was prepared in a same manner as in Example 6, except that in the “preparation of base coat layer coating solution” and “formation of base coat layer”, the aqueous dispersion liquid containing 35% of acrylic latex was changed to an aqueous dispersion liquid containing 35% of acrylonitrile-butadiene latex (minimum film forming temperature: 0° C., product name: NIPOL 1561, manufactured by Nippon Zeon Company Limited), and the recording medium was not subjected to soft calender treatment. The base coat layers formed at this stage respectively had a thickness of 10.2 μm, and the top coat layers formed at this stage respectively had a thickness of 9.3 μm. Further, similarly to Example 6, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 12

A recording medium was prepared in a same manner as in Example 6, except that in the preparation of a base coat layer coating solution, the use amount of the dispersion liquid containing 45% of titanium dioxide was changed from 3.9 parts to 8.6 parts. The base coat layers formed at this stage respectively had a thickness of 9.0 μm, and the top coat layers formed at this stage respectively had a thickness of 9.6 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 13

### Preparation of First Layer (Base Coat Layer) Coating Solution

### (1) Preparation of Acetoacetyl-Modified Polyvinyl Alcohol

Into 88 parts of water, 12 parts of acetoacetyl-modified polyvinyl alcohol (saponification degree: 95% to 97%; polymerization degree: 1,000; product name: GOHSEFIMER Z-210, manufactured by Nippon Synthetic Chemical Industry Co., Ltd.) were added and dissolved at 90° C. or higher with stirring.

(2) Aqueous Solution Containing 50% of 2,3-dihydroxy-5-methyl-1,4-dioxane
(3) Solution Containing 1.66% of Ethyleneoxide Surfactant (Dissolved in Methanol) (Product Name: EMALEX 710 Manufactured by Japan Emulsion Co. Ltd.)

Into 100 parts of the 12% acetoacetyl-modified polyvinyl alcohol solution (1), 58 parts of water were added and sufficiently stirred and mixed, 24 parts of the aqueous solution containing 50% of 2,3-dihydroxy-5-methyl-1,4-dioxane (2) were added thereto and sufficiently stirred and mixed, and 3 parts of the solution containing 1.66% of ethyleneoxide surfactant (3) were added. The liquid temperature of the obtained mixture liquid was maintained at 30° C. to 35° C., and a base coat layer coating solution was thus obtained.

### <Preparation of Second Layer (Top Coat Layer) Coating Solution>

Forty parts of heavy calcium carbonate (product name: ESCALON #2000, manufactured by Sankyo Seifun Co., Ltd.), 40 parts of kaolin (product name: MIRAGLOSS, manufactured by Engelhard Corporation: U.S.), 20 parts of titanium oxide (TIPAQUE R-780, manufactured by ISHIHARA INDUSTRY CO., LTD.), 0.5 parts of a liquid containing 43% of sodium polyacrylate (product name: ARON T-50, manufactured by TOAGOSEI CO., LTD.) were mixed to prepare a mixture, and the mixture was dispersed using an NBK-2 manufactured by Nippon Seiki Co., Ltd. Into the dispersion liquid, 13 parts of styrene-butadiene copolymer latex having an average particle diameter of 95 nm (product name: SMARTEX PA2323, manufactured by Nippon A&L Inc.), 3 parts by mass of starch oxide (product name: ACE B, manufactured by Oji Cornstarch Co., Ltd.) and 1 part of lubricant (product name: SN COAT 231SP, manufactured by Sunnopco Co. Ltd) were added, and a top coat coating solution having a final solid content concentration of 65% was thus prepared.

### <Formation of First Layer (Base Coat Layer)>

On both surfaces of high-quality paper having a basis weight of 81.4 g/m² (product name: SHIRAOI, manufactured by Nippon Paper Industries Co., Ltd.), the obtained base coat layer coating solution was applied using a bar coater so that the coated amount per one surface became 3.5 g/m², and each of the coated surfaces was dried at 50° C. for 3 minutes, thereby forming a base coat layer. The base coat layers formed at this stage respectively had a thickness of 3.4 μm per one surface.

### <Formation of Second Layer (Top Coat Layer)>

On both surfaces of the high-quality paper with the base coat layers provided, the prepared top coat layer coating solution was applied using a high-speed leaf blade coater (product name: PM-9040M, SMT Co., Ltd.) so that the dry mass per one surface became 10 g/m², and each of the coated surfaces was dried at a temperature of 150° C. and a wind velocity of 20 m/sec for 3 seconds, thereby forming a top coat layer. The top coat layers formed at this stage respectively had a thickness of 10.3 μm per one surface. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 14

A recording medium was prepared in a similar manner to those in Example 13, except that in the preparation of a top coat layer coating solution, instead of using 40 parts of heavy calcium carbonate (product name: ESCALON #2000, manufactured by Sankyo Seifun Co., Ltd.), 40 parts of kaolin (product name: MIRAGLOSS, manufactured by Engelhard Corporation: U.S.), and 13 parts of styrene-butadiene copolymer latex having an average particle diameter of 95 nm (product name: SMARTEX PA2323, manufactured by Nippon A&L Inc.), 70 parts of heavy calcium carbonate (product name: ESCALON #2000, manufactured by Sankyo Seifun Co., Ltd.), 10 parts of kaolin (product name: MIRAGLOSS, manufactured by Engelhard Corporation: U.S.), and 9 parts of styrene-butadiene copolymer latex having an average particle diameter of 95 nm (product name: SMARTEX PA2323, manufactured by Nippon A&L Inc.) were used. The base coat layers formed at this stage respectively had a thickness of 3.5 μm, and the top coat layers formed at this stage respectively had a thickness of 10.5 μm. Further, similarly to Example 13, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Example 15

A recording medium was prepared in a same manner as in Example 4, except that the “preparation of top coat layer coating solution” in Example 4 was changed as described below.

### <Preparation of Ink Absorption Layer (Top Coat Layer) Coating Solution>

Ten parts of kaolin (product name: MIRAGLOSS, manufactured by Engelhard Corporation: U.S.), 90 parts of titanium oxide (TIPAQUE R-780, manufactured by ISHIHARA INDUSTRY CO., LTD.), 0.5 parts of a liquid containing 43% of sodium polyacrylate (product name: ARON T-50, manufactured by TOAGOSEI CO., LTD.) were mixed to prepare a mixture, and the mixture was dispersed using an NBK-2 manufactured by Nippon Seiki Co., Ltd. Into the dispersion liquid, 11 parts of styrene-butadiene copolymer latex having an average particle diameter of 95 nm (product name: SMARTEX PA2323, manufactured by Nippon A&L Inc.), 3 parts by mass of starch oxide (product name: ACE B, manufactured by Oji Cornstarch Co., Ltd.), 9 parts of an aqueous solution containing 30% of phosphoric acid, and 1 part of lubricant (product name: SN COAT 231SP, manufactured by Sunnopco Co. Ltd) were added, and a top coat coating solution having a final solid content concentration of 65% was thus prepared.

The base coat layers formed at this stage respectively had a thickness of 3.4 μm, the top coat layers formed at this stage respectively had a thickness of 12.0 μm and the paper surface pH was 3.4. Further, similarly to Example 4, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. It should be noted that the ink used in the “ink droplet jetting test” was the same as used in Example 1, but the formation of an image was carried out without using a treatment liquid, according to the following method. Table 1-1 and Table 1-2 show the test results.

### <Formation of Image>

An image was formed according to a four-color-single pass printing mode using an image forming apparatus as illustrated in FIG. 2 through the use of the cyan pigment ink C, magenta pigment ink M, yellow pigment ink Y, black pigment ink K described in Example 1 under the following conditions.

### —Ink Image Formation—

Head: piezo full-line head of 1,200 dpi/20 inch width arranged for each of four colors
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

Wind velocity: 15 m/s
Temperature: The recording medium was heated from its back surface thereof using a contact type flat heater such that the surface temperature of the recording medium became 60° C.
Air blasted region: 640 mm (drying time: 1 sec.)

### —Fixing—

Silicone rubber roller (hardness: 50 degrees, nip width: 5 mm)
Temperature of roller: 90° C.
Pressure applied: 0.8 MPa

### <Evaluation of Ink Droplet Jetting Test Result>

A gray scale image and a character image (letter image) formed for evaluation were visually checked and evaluated according to the following criteria.

### [Evaluation Criteria]

AA: No image bleeding and inter-color mixing of neighboring colors was observed, and a Kanji letter with densely packed linespacing, [symbol] , in 4 pt could be resolved.

BB: No image bleeding and inter-color mixing of neighboring colors was observed, and a Kanji letter with densely packed linespacing, [symbol] , in 5 pt could be resolved.

CC: A large number of image bleeding and inter-color mixing of neighboring colors were observed, and the practical usability of the recording medium was low.

DD: A substantial amount of image bleeding and inter-color mixing of neighboring colors were observed, and the practical usability of the recording medium was significantly low.

### Example 16

### Preparation of First Layer (Base Coat Layer) Coating Solution

Into 100 parts of an aqueous solution containing 22.5% of polyester urethane latex (glass transition temperature: 49° C., minimum film forming temperature: 29° C., product name: HYDRAN AP-40F, manufactured by Dainippon Ink and Chemicals, Inc.), 6.8 parts of water and 0.7 parts of an aqueous solution containing 10% of EMULGEN 109P (manufactured by Kao Corp.) were added, sufficiently stirred and mixed, the liquid temperature of the obtained mixture liquid was maintained at 15° C. to 25° C., thereby obtaining a 21.0% base coat layer coating solution.

### <Formation of Base Coat Layer>

On both surfaces of high-quality paper having a basis weight of 81.4 g/m² (product name: SHIRAOI, manufactured by Nippon Paper Industries Co., Ltd.), the obtained base coat layer coating solution was applied using a bar coater so that the coated amount per one surface became 8.0 g/m², and each of the coated surfaces was dried at 70° C. for 3 minutes, thereby forming a base coat layer. The base coat layers formed at this stage respectively had a thickness of 7.1 μm per one surface. Further, the recording medium with the base coat layer formed on both surfaces thereof was subjected to soft calender treatment.

### —Soft Calender Treatment—

The high-quality paper with the base coat layer formed on both surfaces thereof was subjected to soft calender treatment using a soft calender equipped with a pair of rolls composed of a metal roll and a resin roll under the conditions that the surface temperature of the metal roll was 50° C., and the nip pressure was 50 kg/cm.

### <Preparation of Second Layer (Top Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.3 parts of a liquid containing 40% of sodium polyacrylate (product name: ARON T-50, manufactured by TOAGOSEI CO., LTD.) and 49.6 parts of water were mixed and dispersed using a non-bubbling kneader (product name: NBK-2 manufactured by Nippon Seiki Co., Ltd.), thereby obtaining a dispersion liquid containing 65% of kaolin. Into the dispersion liquid, 14 parts of a liquid containing 50% of styrene-butadiene copolymer latex having an average particle diameter of 130 nm (product name: NIPOL LX407K, manufactured by Nippon Zeon Company Limited), 1 part of fatty acid calcium emulsion (product name: NOPCOAT C-104-HS, manufactured by Sunnopco Co. Ltd), 10 parts of a liquid containing 1% of carboxymethyl cellulose sodium salt (product name: CELLOGEN EP, manufactured by Dai-ichi Kogyo Seiyaku Co., Ltd.) and 0.5 parts of an aqueous solution containing 10% of EMULGEN 109P (manufactured by Kao Corp.) were added, thereby preparing a top coat coating solution having a final solid content concentration of 59%. The high-shear viscosity of the top coat layer coating solution was 50.2 mPa·s to 138.2 mPa·s.

### <Formation of Second Layer (Top Coat Layer)>

On both surfaces of the high-quality paper with the base coat layers provided, the prepared top coat layer coating solution was applied using a high-speed leaf blade coater (product name: PM-9040M, SMT Co., Ltd.) so that the dry mass per one surface became 20 g/m², and each of the coated surfaces was dried at a temperature of 150° C. and a wind velocity of 20 m/sec for 3 seconds, thereby forming a top coat layer. The top coat layers formed at this stage respectively had a thickness of 20.0 μm per one surface.

—Cobb Water Absorption Test of High-Quality Paper with Base Coat Layer Formed on Both Surfaces Thereof—

(1) Cobb absorption degree (amount of water permeated (g/m²) when being contact with 20° C. water for 15 sec.) of the coated surface of the high-quality paper with the base coat layer formed on both surfaces thereof was measured according to the water absorption test method defined in JIS P8140.

(2) Cobb absorption degree (amount of water permeated (g/m²) when being contact with 20° C. water for 2 min.) of the coated surface of the high-quality paper with the base coat layer formed on both surfaces thereof was measured according to the water absorption test method defined in JIS P8140.

(3) Cobb value (amount of diethylene glycol permeated (g/m²) when being contact with 20° C. diethylene glycol for 2 min.) of the coated surface of the high-quality paper with the base coat layer formed on both surfaces thereof was measured according to the water absorption test method defined in JIS P8140.

### —Water Absorption Test of Top Coat Layer—

The water absorption test of the top coat layer was measured based on the Bristow's method as follows.

(1) A top coat layer sample which was cut in A6 size was set on a measurement disc, a head filled with a test liquid was made contact with the surface of the sample, and the sample surface was automatically scanned along a scanning line as shown in FIG. 4 (from an inside toward an outside of the sample) to thereby measure the liquid absorption property of the sample. A relation between a contact time and an amount of liquid absorbed (liquid absorbed amount) was obtained by changing step-by-step the rotation rate of the measurement disc (the contact time between paper and ink). Table 1 shows the water absorbed amount after a contact time of 0.5 sec.

(2) The amount of liquid absorbed was determined in a similar manner to the method described above (1), except that water used in (1) was changed to pure water containing 30% by mass of diethylene glycol. Table 1 shows the amount of liquid absorbed after a contact time of 0.9 sec.

### —High-Shear Viscosity Measurement Method of Top Coat Layer Coating Solution—

The high-shear viscosity of the top coat layer coating solution was measured as follows. Firstly, with the use of a HERCULES high-shear viscometer (HERCULES HIGH-SHEAR VISCOMETER, manufactured by Kumagai Riki Kogyo Co., Ltd.), an appropriate amount of the top coat layer coating solution was poured in a cup of 40 mm in inner diameter and 80.5 mm in effective depth, the sweep time was set to 10 sec. and the maximum number of rotations was set to 8,800 rpm, and a flow curve ([shearing rate (rpm)]−[shear stress (torque) curve] was determined using a bob F (rotator) having a diameter of 39.8 mm and an effective length of 25 mm (clearance with respect to the cup: 0.1 mm), and from the flow curve, an appearance viscosity of the top coat layer coating solution was determined.

### —Evaluation of Glossiness of White Paper—

The glossiness of a white background of the recording medium was measured using an angle variable glossiness meter (product name: UGV-5D, manufactured by Suga Tester Co., Ltd.), in which the incident angle was set at 750 and the light receiving angle was set at 75°, according to JIS Z8741 (1997). The glossiness of the white background was evaluated based on the following criteria.

### [Evaluation Criteria]

AA: The glossiness was 50% or higher.

BB: The glossiness was 35% or higher to lower than 50%.

CC: The glossiness was 20% or higher to lower than 35%.

DD: The glossiness was lower than 20%.

### —Curl Property Test—

Onto the recording medium with the second layer (top coat layer) formed on both surfaces thereof, water was applied so that the amount of water absorbed to a test specimen of 50 mm×5 mm in size became 10 g/m² in respective directions of MD and CD of the specimen. According to the measurement method of a curl curvature defined in No. 15-2:2000 of the Paper Pulp test method (Japan TAPPI), the specimen was left intact under the conditions of 23° C. and 50% RH for 8 hours, and the curl degree of the specimen was measured and evaluated based on the following criteria.

### [Evaluation Criteria]

AAA: The curl degree was lower than 5.

AA: The curl degree was 5 or higher to lower than 10.

BB: The curl degree was 10 or higher to lower than 20.

CC: The curl degree was 20 or higher to lower than 30.

DD: The curl degree was 30 or higher.

—Evaluation of Cockling Resistance Immediately after Image Formation—

On a recording medium in a postcard size with the top coat layer formed on both surfaces thereof, a solid image of 100% monochrome and 2 cm×2 cm in size was printed at a center portion of the postcard-size recording medium, and a maximum height of wavy portions that were caused immediately after the image formation was measured using a laser displacement meter. The measurement results were evaluated based on the following criteria.

### [Evaluation Criteria]

AA: The maximum height was 1 mm or higher to less than 2 mm.

BB: The maximum height was 2 mm or higher to less than 3 mm.

CC: The maximum height was 3 mm or higher.

### —Evaluation of Image Density Uniformity—

The monochrome 100% solid image which was formed on the postcard size recording medium for evaluating the cockling resistance was visually checked and evaluated in accordance with the following criteria.

### [Evaluation Criteria]

AA: The density corresponding to the solid image area was uniform, and no white void (ink void) and ink spot was observed.

BB: A small number of white voids (ink voids) and ink spots were observed, but there is no problem in practical use.

CC: A large number of white voids (ink voids) and ink spots were observed, but the practical usability was low.

DD: A substantial number of white voids (ink voids) and ink spots were observed, but the practical usability was significantly low.

### —Ink Droplet Jetting Test—

### <Preparation of Ink>

### (1) Preparation of Cyan Pigment Ink C

### (Preparation of Pigment Dispersion)

In a vessel, 10 g of CYANINE BLUE A-22 (C.I. PB 15:3) manufactured by Dainichiseika Color & Chemicals Mfg. Co., Ltd., 10.0 g of a low-molecular weight dispersant 2-1, 4.0 g of glycerin and 26 g of ion exchange water were stirred and mixed to prepare a dispersion liquid. Next, the dispersion liquid was intermittently irradiated (irradiated: 0.5 sec. and paused: 1.0 sec.) with a supersonic wave for 2 hours using supersonic irradiation equipment (VIBRA-CELL VC-750, manufactured by SONICS; taper micro chip: φ5 mm, amplitude: 30%) so as to further disperse the pigment, thereby preparing 20% by mass of a pigment dispersion liquid. Note that the low-molecular weight dispersant 2-1 is represented by the following Chemical Formula.

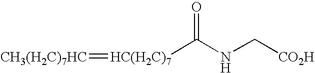

Separately from the pigment dispersion liquid, the following compound was weighed, stirred and mixed to prepare a mixture liquid I.

| | |
|---|---|
| glycerin | 5.0 g |
| diethylene glycol | 10.0 g |
| OLFIN E1010 (manufactured by Nisshin Kagaku Co., Ltd.) | 1.0 g |
| ion exchange water | 11.0 g |

This mixture liquid I was slowly delivered by drops in 23.0 g of a stirred dispersion liquid containing 44% of SBR(polymer fine particle: 3% by mass of acrylic acid, glass transition temperature (Tg) of 30° C.), stirred and mixed to prepare a mixture liquid II.

The mixture liquid II was slowly delivered by drops in 20% by mass of the pigment dispersion liquid, stirred and mixed to prepare 100 g of a cyan color pigment ink C (cyan ink). The pH of the pigment ink C thus prepared was measured using a pH meter WM-50EG manufactured by Toa Denpa Kogyo K.K. The pigment ink C had a pH of 8.5.

### (2) Preparation of Magenta Pigment Ink M

A magenta pigment ink M (magenta color) was prepared in a similar manner to the Preparation of Pigment Ink C, except that CROMOPHTAL JET MAGENTA DMQ (PR-122) available from Chiba Specialty Chemicals K.K. was used in place of the pigment used in the formulation of Preparation of Pigment Ink C. The pH of the pigment ink M thus prepared was measured using a pH meter WM-50EG manufactured by Toa Denpa Kogyo K.K. The pigment ink M had a pH of 8.5.

### (3) Preparation of Yellow Pigment Ink Y

A yellow pigment ink Y (yellow color) was prepared in a similar manner to the Preparation of Pigment Ink C, except that IRGALITE YELLOW GS (PY74) available from Chiba Specialty Chemicals K.K. was used in place of the pigment used in the formulation of Preparation of Pigment Ink C. The pH of the pigment ink Y thus prepared was measured using a pH meter WM-50EG manufactured by Toa Denpa Kogyo K.K. The pigment ink Y had a pH of 8.5.

### (4) Preparation of Black Pigment Ink K

A black pigment ink K (black color) was prepared in a similar manner to the Preparation of Pigment Ink C, except that CAB-O-JET TM_{—}200 (carbon black) available from CABOT Corp. was used in place of the pigment used in the formulation of Preparation of Pigment Ink C. The pH of the pigment ink K thus prepared was measured using a pH meter WM-50EG manufactured by Toa Denpa Kogyo K.K. The pigment ink K had a pH of 8.5.

### <Preparation of Treatment Liquid>

The following materials were mixed to prepare a treatment liquid:

| | |
|---|---|
| phosphoric acid | 10 g |
| glycerin | 20 g |
| diethylene glycol | 10 g |
| OLFIN E1010 (manufactured by Nisshin Kagaku Co., Ltd.) | 1 g |
| ion exchange water | 59 g |

The pH of the first treatment liquid thus prepared was measured using a pH meter WM-50EG. The first treatment liquid had a pH of 1.0.

### <Ink Droplet Jetting Mode>

An image was formed according to a four-color-single pass printing mode using an image forming apparatus as illustrated in FIG. 3 through the use of the cyan pigment ink C, magenta pigment ink M, yellow pigment ink Y, black pigment ink K and treatment liquid under the following conditions.

### —Treatment Liquid Head for Pre-Coat Module—

Head: piezo full-line head of 600 dpi/20 inch width
Amount of liquid droplets ejected: two-value recording using 0 pL and 4.0 pL
Drive frequency: 15 kHz (conveyance rate of recording medium: 635 mm/sec)
Pattern of image formation: in an ink image forming step, a pattern was used in which a treatment liquid was previously applied to a region of a recording medium at which an image was to be formed with at least one or more color inks.

### —Drying of Water (Drying by Air Blasting) for Pre-Coat Module—

Wind velocity: 15 m/s
Temperature: The recording medium was heated from its back surface thereof using a contact type flat heater such that the surface temperature of the recording medium became 60° C.
Air blasted region: 450 mm (drying time: 0.7 sec.)

### —Ink Image Formation—

Head: piezo full-line head of 1,200 dpi/20 inch width arranged for each of four colors
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

Wind velocity: 15 m/s
Temperature: 60° C.
Air blasted region: 640 mm (drying time: 1 sec.)

### —Fixing—

Silicone rubber roller (hardness: 50 degrees, nip width: 5 mm)
Temperature of roller: 90° C.
Pressure applied: 0.8 MPa

### <Evaluation Method>

A gray scale image and a character image (letter image) formed for evaluation were visually checked and evaluated according to the following criteria.

### [Evaluation Criteria]

AA: No image bleeding and inter-color mixing of neighboring colors was observed, and a Kanji letter with densely packed linespacing, [symbol] , in 4 pt could be resolved.

BB: No image bleeding and inter-color mixing of neighboring colors was observed, and a Kanji letter with densely packed linespacing, [symbol] , in 5 pt could be resolved.

CC: A large number of image bleeding and inter-color mixing of neighboring colors were observed, and the practical usability of the recording medium was low.

DD: A substantial amount of image bleeding and inter-color mixing of neighboring colors were observed, and the practical usability of the recording medium was significantly low.

### Example 17

A recording medium was prepared in a similar manner to those in Example 16, except that the “preparation of base coat layer coating solution” was changed as follows. The base coat layers formed at this stage respectively had a thickness of 8.1 μm, and the top coat layers formed at this stage respectively had a thickness of 20.6 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### <Preparation of First Layer (Base Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.3 parts of a liquid containing 40% of sodium polyacrylate (product name: ARON T-50, manufactured by TOAGOSEI CO., LTD.) and 49.6 parts of water were mixed and dispersed using a non-bubbling kneader (product name: NBK-2 manufactured by Nippon Seiki Co., Ltd.), thereby obtaining a dispersion liquid containing 65% of kaolin. Next, into 100 parts of an aqueous dispersion liquid containing 22.5% of polyester urethane latex (glass transition temperature: 49° C.; minimum film forming temperature: 29° C.; product name: HYDRAN AP-40F, manufactured by Dainippon Ink and Chemicals, Inc.), 5 parts of water, 7.0 parts of the obtained dispersion liquid containing 65% of kaolin and 0.8 parts of an aqueous solution containing 10% of EMULGEN 109P (manufactured by Kao Corp.) were added, sufficiently stirred and mixed, and the liquid temperature of the obtained mixture was maintained at 15° C. to 25° C., thereby obtaining a 24.0% base coat layer coating solution.

### Example 18

A recording medium was prepared in a same manner as in Example 17, except that in the “formation of top coat layer”, the recording medium was subjected to the soft calender treatment as follows. The base coat layers formed at this stage respectively had a thickness of 8.1 μm, and the top coat layers formed at this stage respectively had a thickness of 19.1 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### —Soft Calender Treatment—

The high-quality paper with the base coat layer formed on both surfaces thereof was subjected to soft calender treatment using a soft calender equipped with a pair of rolls composed of a metal roll and a resin roll under the conditions that the surface temperature of the metal roll was 80° C., and the nip pressure was 50 kg/cm.

### Example 19

A recording medium was prepared in a similar manner to those in Example 18, except that in the “preparation of top coat layer coating solution” and “formation of top coat layer”, the conditions were changed as follows. The base coat layers formed at this stage respectively had a thickness of 8.1 μm, and the top coat layers formed at this stage respectively had a thickness of 20.9 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### <Preparation of Second Layer (Top Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.3 parts of a liquid containing 40% of sodium polyacrylate (product name: ARON T-50, manufactured by TOAGOSEI CO., LTD.) and 49.6 parts of water were mixed and dispersed using a non-bubbling kneader (product name: NBK-2 manufactured by Nippon Seiki Co., Ltd.), thereby obtaining a dispersion liquid containing 65% of kaolin. Into the dispersion liquid, 14 parts of a liquid containing 50% of styrene-butadiene copolymer latex having an average particle diameter of 130 nm (product name: NIPOL LX407K, manufactured by Nippon Zeon Company Limited), 1 part of fatty acid calcium emulsion (product name: NOPCOAT C-104-HS, manufactured by Sunnopco Co. Ltd), 10 parts of a liquid containing 1% of carboxymethyl cellulose sodium salt (product name: CELLOGEN EP, manufactured by Dai-ichi Kogyo Seiyaku Co., Ltd.) and 0.5 parts of an aqueous solution containing 10% of EMULGEN 109P (manufactured by Kao Corp.) were added, thereby preparing a top coat coating solution having a final solid content concentration of 27%.

### <Formation of Second Layer (Top Coat Layer)>

On both surfaces of the high-quality paper with the base coat layers provided, the prepared top coat layer coating solution was applied using a bar coater so that the dry mass per one surface became 20 g/m², and each of the coated surfaces was dried at a temperature of 70° C. for 5 minutes, thereby forming a top coat layer.

### Example 20

A recording medium was prepared in a same manner as in Example 16, except that the “preparation of base coat layer coating solution” was changed as follows. The base coat layers formed at this stage respectively had a thickness of 5.1 μm, and the top coat layers formed at this stage respectively had a thickness of 20.0 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### <Preparation of First Layer (Base Coat Layer) Coating Solution>

Into 100 parts of an aqueous dispersion liquid containing 29.9% of acrylic silicone latex (glass transition temperature: 25° C., minimum film forming temperature: 20° C.; product name: AQUABRID ASI-91 manufactured by DAICEL CHEMICAL INDUSTRIES, LTD.), 41.9 parts of water and 0.9 parts of 10% aqueous solution of an aqueous solution containing 10% of EMULGEN 109P (manufactured by Kao Corp.) were added, sufficiently stirred and mixed, and the liquid temperature of the obtained mixture liquid was maintained at 15° C. to 25° C., thereby obtaining a 21.0% base coat layer coating solution.

### Example 21

A recording medium was prepared in a same manner as in Example 16, except that the “preparation of base coat layer coating solution” was changed as follows. The base coat layers formed at this stage respectively had a thickness of 7.4 μm, and the top coat layers formed at this stage respectively had a thickness of 20.0 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### <Preparation of First Layer (Base Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.3 parts of a liquid containing 40% of sodium polyacrylate (product name: ARON T-50, manufactured by TOAGOSEI CO., LTD.) and 49.6 parts of water were mixed and dispersed using a non-bubbling kneader (product name: NBK-2 manufactured by Nippon Seiki Co., Ltd.), thereby obtaining a dispersion liquid containing 65% of kaolin. Next, into 100 parts of an aqueous dispersion liquid containing 29.9% of acrylic silicone latex (glass transition temperature: 25° C., minimum film forming temperature: 20° C., product name: AQUABRID ASI-91, manufactured by DAICEL CHEMICAL INDUSTRIES, LTD.), 7 parts of water, 13.9 parts of the obtained dispersion liquid containing 65% of kaolin and 1 part of an aqueous solution containing 10% of EMULGEN 109P (manufactured by Kao Corp.) were added, sufficiently stirred and mixed, and the liquid temperature of the obtained mixture liquid was maintained at 15° C. to 25° C., thereby obtaining a 32.0% base coat layer coating solution.

### Example 22

A recording medium was prepared in a same manner as in Example 16, except that the “preparation of base coat layer coating solution” and “formation of base coat layer” were respectively changed as follows. The base coat layers formed at this stage respectively had a thickness of 6.2 μm, and the top coat layers formed at this stage respectively had a thickness of 20.4 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### <Preparation of First Layer (Base Coat Layer) Coating Solution>

Into 100 parts of an aqueous dispersion liquid containing 22.5% of polyester urethane latex (glass transition temperature: 49° C., minimum film forming temperature: 29° C.; product name: HYDRAN AP-40F, manufactured by Dainippon Ink and Chemicals, Inc.), 4.4 parts of water, 35.7 parts of a slurry containing 63% of kaolin (product name: CONTOUR 1500, manufactured by Imerys Minerals Japan K.K.), and 0.8 parts of an aqueous solution containing 10% of EMULGEN 109P (manufactured by Kao Corp.) were added, sufficiently stirred and mixed, and the liquid temperature of the obtained mixture liquid was maintained at 15° C. to 25° C., thereby obtaining a 32.0% base coat layer coating solution.

### <Formation of Base Coat Layer>

On both surfaces of high-quality paper having a basis weight of 81.4 g/m² (product name: SHIRAOI, manufactured by Nippon Paper Industries Co., Ltd.), the obtained base coat layer coating solution was applied using a high-speed leaf blade coater (product name: PM-9040M, SMT Co., Ltd.) so that the dry mass per one surface became 7.0 g/m², and each of the coated surfaces was dried at a temperature of 150° C. and a wind velocity of 20 m/sec for 3 seconds, thereby forming a base coat layer.

### Example 23

A recording medium was prepared in a same manner as in Example 16, except that the “preparation of base coat layer coating solution” and “formation of base coat layer” were respectively changed as follows. The base coat layers formed at this stage respectively had a thickness of 6.8 μm, and the top coat layers formed at this stage respectively had a thickness of 20.4 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### <Preparation of First Layer (Base Coat Layer) Coating Solution>

Into 100 parts of an aqueous dispersion liquid containing 22.5% of polyester urethane latex (glass transition temperature: 49° C., minimum film forming temperature: 29° C.; product name: HYDRAN AP-40F, manufactured by Dainippon Ink and Chemicals, Inc.), 3.4 parts of water, 26.7 parts of a slurry containing 67.5% of kaolin (product name: ASTRAPLATE, manufactured by Imerys Minerals Japan K.K.) and 0.8 parts of an aqueous solution containing 10% of EMULGEN 109P (manufactured by Kao Corp.) were added, sufficiently stirred and mixed, and the liquid temperature of the obtained mixture liquid was maintained at 15° C. to 25° C., thereby obtaining a 31.0% base coat coating solution.

### <Formation of Base Coat Layer>

On both surfaces of high-quality paper having a basis weight of 81.4 g/m² (product name: SHIRAOI, manufactured by Nippon Paper Industries Co., Ltd.), the obtained base coat layer coating solution was applied using a high-speed leaf blade coater (product name: PM-9040M, SMT Co., Ltd.) so that the dry mass per one surface became 8.0 g/m², and each of the coated surfaces was dried at a temperature of 150° C. and a wind velocity of 20 m/sec for 3 seconds, thereby forming a base coat layer.

### Comparative Example 1

A recording medium was prepared in a same manner as in Example 1, except that in the formation of a base coat layer, the coated amount of the base coat layer coating solution per one surface was changed from 8.0 g/m² to 6.0 g/m². The base coat layers formed at this stage respectively had a thickness of 5.8 μm, and the top coat layers formed at this stage respectively had a thickness of 9.8 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Comparative Example 2

A recording medium was prepared in a same manner as in Example 3, except that in the preparation of a top coat layer coating solution, 40 parts of heavy calcium carbonate (product name: ESCALON #2000, manufactured by Sankyo Seifun Co., Ltd.), 40 parts of kaolin (product name: MIRAGLOSS, manufactured by Engelhard Corporation: U.S.), and 15 parts of styrene-butadiene copolymer latex having an average particle diameter of 95 nm (product name: SMARTEX PA2323, manufactured by Nippon A&L Inc.) were used instead of using 60 parts of heavy calcium carbonate (product name: ESCALON #2000, manufactured by Sankyo Seifun Co., Ltd.), 20 parts of kaolin (product name: MIRAGLOSS, manufactured by Engelhard Corporation: U.S.), 11 parts of styrene-butadiene copolymer latex having an average particle diameter of 95 nm (product name: SMARTEX PA2323, manufactured by Nippon A&L Inc.). The base coat layers formed at this stage respectively had a thickness of 4.3 μm, and the top coat layers formed at this stage respectively had a thickness of 11.0 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Comparative Example 3

A recording medium was prepared in a same manner as in Example 3, except that in the preparation of a top coat layer coating solution, 70 parts of heavy calcium carbonate (product name: ESCALON #2000, manufactured by Sankyo Seifun Co., Ltd.), 15 parts of kaolin (product name: MIRAGLOSS, manufactured by Engelhard

Corporation: U.S.), 15 parts of titanium oxide (TIPAQUE R-780, manufactured by ISHIHARA INDUSTRY CO., LTD.) and 9 parts of styrene-butadiene copolymer latex having an average particle diameter of 95 nm (product name: SMARTEX PA2323, manufactured by Nippon A&L Inc.) were used instead of using 60 parts of heavy calcium carbonate (product name: ESCALON #2000, manufactured by Sankyo Seifun Co., Ltd.), 20 parts of kaolin (product name: MIRAGLOSS, manufactured by Engelhard Corporation: U.S.), 20 parts of titanium oxide (TIPAQUE R-780, manufactured by ISHIHARA INDUSTRY CO., LTD.) and 11 parts of styrene-butadiene copolymer latex having an average particle diameter of 95 nm (product name: SMARTEX PA2323, manufactured by Nippon A&L Inc.). The base coat layers formed at this stage respectively had a thickness of 4.6 μm, and the top coat layers formed at this stage respectively had a thickness of 10.6 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Comparative Example 4

A recording medium was prepared in a same manner as in Example 6, except that in the “formation of base coat layer”, soft calender treatment was not carried out; and in the preparation of a top coat layer coating solution, 40 parts of heavy calcium carbonate (product name: ESCALON #2000, manufactured by Sankyo Seifun Co., Ltd.), 50 parts of kaolin (product name: MIRAGLOSS, manufactured by Engelhard Corporation: U.S.), 10 parts of titanium oxide (TIPAQUE R-780, manufactured by ISHIHARA INDUSTRY CO., LTD.) and 15 parts of styrene-butadiene copolymer latex having an average particle diameter of 95 nm (product name: SMARTEX PA2323, manufactured by Nippon A&L Inc.) were used instead of using 60 parts of heavy calcium carbonate (product name: ESCALON #2000, manufactured by Sankyo Seifun Co., Ltd.), 20 parts of kaolin (product name: MIRAGLOSS, manufactured by Engelhard Corporation: U.S.), 20 parts of titanium oxide (TIPAQUE R-780, manufactured by ISHIHARA INDUSTRY CO., LTD.) and 11 parts of styrene-butadiene copolymer latex having an average particle diameter of 95 nm (product name: SMARTEX PA2323, manufactured by Nippon A&L Inc.). The base coat layers formed at this stage respectively had a thickness of 10.2 μm, and the top coat layers formed at this stage respectively had a thickness of 10.1 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Comparative Example 5

A recording medium was prepared in a same manner as in Example 6, except that in the “preparation of base coat layer coating solution”, the use amount of 45% of the titanium dioxide dispersion liquid was changed from 3.9 parts to 11.7 parts; and in the “preparation of top coat layer coating solution”, 70 parts of heavy calcium carbonate (product name: ESCALON #2000, manufactured by Sankyo Seifun Co., Ltd.), 10 parts of kaolin (product name: MIRAGLOSS, manufactured by Engelhard Corporation: U.S.), 20 parts of titanium oxide (TIPAQUE R-780, manufactured by ISHIHARA INDUSTRY CO., LTD.) and 7 parts of styrene-butadiene copolymer latex having an average particle diameter of 95 nm (product name: SMARTEX PA2323, manufactured by Nippon A&L Inc.) were used instead of using 60 parts of heavy calcium carbonate (product name: ESCALON #2000, manufactured by Sankyo Seifun Co., Ltd.), 20 parts of kaolin (product name: MIRAGLOSS, manufactured by Engelhard Corporation: U.S.), 20 parts of titanium oxide (TIPAQUE R-780, manufactured by ISHIHARA INDUSTRY CO., LTD.) and 11 parts of styrene-butadiene copolymer latex having an average particle diameter of 95 nm (product name: SMARTEX PA2323, manufactured by Nippon A&L Inc.). The base coat layers formed at this stage respectively had a thickness of 9.6 μm, and the top coat layers formed at this stage respectively had a thickness of 9.8 μm. Further, similarly to Example 1, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### Comparative Example 6

A recording medium was prepared in a same manner as in Example 16, except that in the “formation of base coat layer”, the coated amount of the base coat layer coating solution per one surface was changed from 8.0 g/m² to 4.0 g/m². The base coat layers formed at this stage respectively had a thickness of 3.8 μm, and the top coat layers formed at this stage respectively had a thickness of 18.9 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### Comparative Example 7

A recording medium was prepared in a same manner as in Example 17, except that in the “formation of base coat layer”, the coated amount of the base coat layer coating solution per one surface was changed from 8.0 g/m² to 4.0 g/m². The base coat layers formed at this stage respectively had a thickness of 4.0 μm, and the top coat layers formed at this stage respectively had a thickness of 20.6 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results. The high-shear viscosity of the top coat layer coating solution was 50.2 mPa·s to 138.2 mPa·s.

### Comparative Example 8

A recording medium was prepared in a same manner as in Comparative Example 7, except that the “preparation of top coat layer coating solution” was changed as follows, and the recording medium was subjected to soft calender treatment. The base coat layers formed at this stage respectively had a thickness of 4.0 μm, and the top coat layers formed at this stage respectively had a thickness of 5.1 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### <Preparation of Second Layer (Top Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.3 parts of a liquid containing 40% of sodium polyacrylate (product name: ARON T-50, manufactured by TOAGOSEI CO., LTD.) and 49.6 parts of water were mixed and dispersed using a non-bubbling kneader (product name: NBK-2 manufactured by Nippon Seiki Co., Ltd.), thereby obtaining a dispersion liquid containing 65% of kaolin. Into the dispersion liquid, 14 parts of a liquid containing 50% of styrene-butadiene copolymer latex having an average particle diameter of 130 nm (product name: NIPOL LX407K, manufactured by Nippon Zeon Company Limited), 1 part of fatty acid calcium emulsion (product name: NOPCOAT C-104-HS, manufactured by Sunnopco Co. Ltd) were added, thereby preparing a top coat coating solution having a final solid content concentration of 59%. The high-shear viscosity of the top coat layer coating solution was 18.6 mPa·s to 90.2 mPa·s.

### —Soft Calender Treatment—

The high-quality paper with the base coat layer formed on both surfaces thereof was subjected to soft calender treatment using a soft calender equipped with a pair of rolls composed of a metal roll and a resin roll under the conditions that the surface temperature of the metal roll was 80° C. and the nip pressure was 50 kg/cm.

### Comparative Example 9

A recording medium was prepared in a same manner as in Comparative Example 8, except that the “preparation of top coat layer coating solution” and “formation of top coat layer” were respectively changed as follows. The base coat layers formed at this stage respectively had a thickness of 4.0 μm, and the top coat layers formed at this stage respectively had a thickness of 19.6 μm. Further, similarly to Example 16, “Cobb water absorption test of high-quality paper with base coat layer formed on both surfaces thereof”, “water absorption test of top coat layer”, “high-shear viscosity measurement of top coat layer coating solution”, “evaluation of glossiness of white paper”, “curl property test”, “ink droplet jetting test”, “test of cockling resistance immediately after image formation” and “test of uniformity of image density” were carried out. Table 1-1 and Table 1-2 show the test results.

### <Preparation of Second Layer (Top Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.3 parts of a liquid containing 40% of sodium polyacrylate (product name: ARON T-50, manufactured by TOAGOSEI CO., LTD.) and 49.6 parts of water were mixed and dispersed using a non-bubbling kneader (product name: NBK-2 manufactured by Nippon Seiki Co., Ltd.), thereby obtaining a dispersion liquid containing 65% of kaolin. Into the dispersion liquid, 14 parts of a liquid containing 50% of styrene-butadiene copolymer latex having an average particle diameter of 130 nm (product name: NIPOL LX407K, manufactured by Nippon Zeon Company Limited), 1 part of fatty acid calcium emulsion (product name: NOPCOAT C-104-HS, manufactured by Sunnopco Co. Ltd), 10 parts of a liquid containing 1% of carboxymethyl cellulose sodium salt (product name: CELLOGEN EP, manufactured by Dai-ichi Kogyo Seiyaku Co., Ltd.) and 0.5 parts of an aqueous solution containing 10% of EMULGEN 109P (manufactured by Kao Corp.) were added, thereby preparing a top coat coating solution having a final solid content concentration of 27%. The high-shear viscosity of the top coat layer coating solution was 17.0 mPa·s to 50.9 mPa·s.

### <Formation of Second Layer (Top Coat Layer)>

On both surfaces of the high-quality paper with the base coat layers provided, the prepared top coat layer coating solution was applied using a bar coater so that the dry mass per one surface became 20 g/m², and each of the coated surfaces was dried at a temperature of 70° C. for 5 minutes, thereby forming a top coat layer.

TABLE 1-1

| | | | | Amount of liquid | |
|---|---|---|---|---|---|
| | Cobb method (g/m2) | | | absorbed | |
| | Water | Water | DEG | Water | Water/DEG |
| | 15 sec | 2 min | 2 min | 0.5 sec | 0.9 sec |
| Ex. 1 | 4.5 | 8.1 | 7.1 | 3.2 | 2.0 |
| Ex. 2 | 4.2 | 7.9 | 6.2 | 3.1 | 2.0 |
| Ex. 3 | 3.5 | 6.2 | 5.7 | 3.3 | 2.0 |
| Ex. 4 | 2.5 | 5.1 | 5.1 | 2.9 | 2.0 |
| Ex. 5 | 2.8 | 3.9 | 4.8 | 2.8 | 2.0 |
| Ex. 6 | 0.3 | 1.4 | 1.2 | 3.1 | 2.0 |
| Ex. 7 | 0.1 | 0.5 | 0.5 | 3.1 | 2.0 |
| Ex. 8 | 1.0 | 1.6 | 1.1 | 3.2 | 2.0 |
| Ex. 9 | 0.2 | 0.9 | 0.9 | 3.3 | 2.0 |
| Ex. 10 | 0.5 | 1.8 | 1.4 | 3.0 | 2.0 |
| Ex. 11 | 0.4 | 1.7 | 1.0 | 2.8 | 2.0 |
| Ex. 12 | 4.8 | 6.8 | 4.7 | 3.1 | 2.0 |
| Ex. 13 | 2.0 | 6.5 | 6.2 | 2.3 | 1.8 |
| Ex. 14 | 2.2 | 6.5 | 6.2 | 7.5 | 2.4 |
| Ex. 15 | 3.2 | 5.1 | 5.1 | 2.5 | 2.5 |
| Ex. 16 | 0.1 | 0.5 | 0.9 | 3.7 | 3.0 |
| Ex. 17 | 0.1 | 0.9 | 1.4 | 3.7 | 3.0 |
| Ex. 18 | 0.1 | 0.9 | 1.4 | 2.8 | 1.8 |
| Ex. 19 | 0.1 | 0.9 | 1.4 | 3.4 | 2.4 |
| Ex. 20 | 0.1 | 0.3 | 0.7 | 3.7 | 3.0 |
| Ex. 21 | 0.1 | 0.6 | 1.2 | 3.7 | 3.0 |
| Ex. 22 | 0.1 | 0.6 | 1.0 | 3.7 | 3.0 |
| Ex. 23 | 0.1 | 0.6 | 1.0 | 3.7 | 3.0 |
| Compara. | 5.2 | 9.2 | 9.9 | 3.0 | 2.2 |
| Ex. 1 | | | | | |
| Compara. | 3.2 | 6.2 | 5.7 | 1.7 | 0.9 |
| Ex. 2 | | | | | |
| Compara. | 3.4 | 5.9 | 5.5 | 8.3 | 7.2 |
| Ex. 3 | | | | | |
| Compara. | 8.1 | 11.2 | 10.7 | 1.1 | 0.8 |
| Ex. 4 | | | | | |
| Compara. | 7.7 | 10.1 | 9.1 | 9.3 | 7.1 |
| Ex. 5 | | | | | |
| Compara. | 5.4 | 8.3 | 8.9 | 3.7 | 3.0 |
| Ex. 6 | | | | | |
| Compara. | 5.7 | 8.4 | 10.1 | 3.7 | 3.0 |
| Ex. 7 | | | | | |
| Compara. | 5.7 | 8.4 | 10.1 | 2.2 | 1.9 |
| Ex. 8 | | | | | |
| Compara. | 5.7 | 8.4 | 10.1 | 11.2 | 8.5 |
| Ex. 9 | | | | | |

*DEG: diethylene glycol

TABLE 1-2

| | Curl | | Cockling | uniformity | | |
|---|---|---|---|---|---|---|
| | property | Ink droplet | resistance | of image | Viscosity | Glossiness |
| | test | jetting test | test | density | (m · Pas) | at 75° |
| Ex. 1 | BB | BB | BB | BB | 44-91 | BB |
| Ex. 2 | BB | BB | BB | BB | 44-91 | BB |
| Ex. 3 | BB | BB | BB | BB | 44-91 | BB |
| Ex. 4 | BB | BB | BB | BB | 44-91 | BB |
| Ex. 5 | BB | BB | BB | BB | 44-91 | BB |
| Ex. 6 | AA | BB | AA | BB | 44-91 | BB |
| Ex. 7 | AA | BB | AA | BB | 44-91 | BB |
| Ex. 8 | AA | BB | BB | BB | 44-91 | BB |
| Ex. 9 | AA | BB | AA | BB | 44-91 | BB |
| Ex. 10 | AA | BB | AA | BB | 44-91 | BB |
| Ex. 11 | AA | BB | AA | BB | 44-91 | BB |
| Ex. 12 | BB | BB | BB | BB | 44-91 | BB |
| Ex. 13 | BB | BB | BB | BB | 53-111 | BB |
| Ex. 14 | BB | AA | BB | BB | 41-78 | CC |
| Ex. 15 | BB | AA | BB | BB | 39-72 | BB |
| Ex. 16 | AAA | BB | BB | BB | 50-138 | CC |
| Ex. 17 | AAA | BB | BB | BB | 50-138 | BB |
| Ex. 18 | AAA | AA | AA | AA | 50-138 | AA |
| Ex. 19 | AAA | BB | BB | BB | 50-138 | DD |
| Ex. 20 | AAA | BB | BB | BB | 50-138 | CC |
| Ex. 21 | AAA | BB | BB | BB | 50-138 | BB |
| Ex. 22 | AAA | BB | BB | BB | 50-138 | BB |
| Ex. 23 | AAA | BB | BB | BB | 50-138 | BB |
| Compara. Ex. 1 | CC | CC | CC | CC | 44-91 | BB |
| Compara. Ex. 2 | BB | CC | BB | CC | 55-124 | BB |
| Compara. Ex. 3 | BB | CC | BB | CC | 42-88 | BB |
| Compara. Ex. 4 | DD | CC | CC | CC | 51-144 | BB |
| Compara. Ex. 5 | DD | CC | CC | CC | 38-71 | BB |
| Compara. Ex. 6 | CC | BB | BB | BB | 50-138 | CC |
| Compara. Ex. 7 | CC | BB | BB | BB | 50-138 | BB |
| Compara. Ex. 8 | CC | CC | BB | CC | 19-90 | AA |
| Compara. Ex. 9 | CC | CC | CC | CC | 17-51 | DD |

The results shown in Tables 1-1 and 1-2 demonstrate that the recording media of Examples 1 to 23 in which the Cobb water absorption degree of the base paper provided with a base coat layer on both surfaces thereof, with a contact time of 15 seconds determined by the water absorption test defined in JIS P 8140 was 5.0 g/m² or less, and the amount of water absorbed by each of the top coat layers after a contact time of 0.5 sec. according to the Bristow's method was within the range of 2 mL/m² to 8 mL/m² were superior in comprehensive evaluation results of curl property test, ink droplet jetting test, cockling resistance test and uniformity of image density to those of the recording media of Comparative Examples 1 to 9, and the use of any of the recording media of Examples 1 to 23 made it possible to prevent the occurrence of paper deformation and image bleeding.

### Example 24

### Preparation of First Layer (Base Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.2 parts of a liquid containing 40% of sodium polyacrylate (product name: ARON T-50, manufactured by TOAGOSEI CO., LTD.) and 48.8 parts of water were mixed and dispersed using a non-bubbling kneader (product name: NBK-2 manufactured by Nippon Seiki Co., Ltd.), thereby obtaining a dispersion liquid containing 65% of kaolin. Next, into 100 parts of an aqueous dispersion liquid containing 22.5% of polyester urethane latex (glass transition temperature: 49° C.; minimum film forming temperature: 29° C.; product name: HYDRAN AP40F, manufactured by Dainippon Ink and Chemicals, Inc.), 5 parts of water, 6.9 parts of the obtained dispersion liquid containing 65% of kaolin and 0.8 parts of an aqueous solution containing 10% of EMULGEN 109P (manufactured by Kao Corp.) were added, sufficiently stirred and mixed, and the liquid temperature of the obtained mixture was maintained at 15° C. to 25° C., thereby obtaining a 24.0% base coat layer coating solution.

### <Preparation of Second Layer (Top Coat Layer) Coating Solution>

One hundred parts of kaolin (product name: KAOBRIGHT 90, manufactured by Shiraishi Calcium Co.), and 1.2 parts of a liquid containing 40% of sodium polyacrylate (product name: ARON T-50, manufactured by TOAGOSEI CO., LTD.) were mixed and dispersed. Into the dispersion liquid, 100 parts of an aqueous solution containing 7% of PVA245 (manufactured by KURARAY Co., Ltd.) and 3.7 parts of an aqueous solution of 10% of EMULGEN 109P (manufactured by Kao Corp.) were added, and a top coat coating solution having a final solid content concentration of 27% was thus prepared.

### <Formation of First Layer (Base Coat Layer)>

On both surfaces of high-quality paper having a basis weight of 81.4 g/m² (product name: SHIRAOI, manufactured by Nippon Paper Industries Co., Ltd.), the obtained base coat layer coating solution was applied using an extrusion die coater so that the coated amount per one surface became 8.0 g/m², and each of the coated surfaces was dried at a temperature of 85° C. and a wind velocity of 15 m/sec for 1 minute, thereby forming a base coat layer.

Further, the recording medium with the base coat layer formed on both surfaces thereof was subjected to soft calender treatment.

### —Soft Calender Treatment—

The high-quality paper with the base coat layer formed on both surfaces thereof was subjected to soft calender treatment using a soft calender equipped with a pair of rolls composed of a metal roll and a resin roll under the conditions that the surface temperature of the metal roll was 50° C. and the nip pressure was 50 kg/cm.

### <Formation of Second Layer>

On both surfaces of the high-quality paper with the base coat layer formed on both surfaces thereof, the prepared second layer coating solution was applied using an extrusion die coater so that the dry mass per one surface became 20 g/m², and each of the coated surfaces was dried at a temperature of 70° C. and a wind velocity of 10 m/sec for 1 minute, thereby forming a second layer. The base coat layers formed at this stage respectively had a thickness of 8.0 μm, the top coat layers formed at this stage respectively had a thickness of 15.3 μm, and the surface pH was 7.4.

The surface pH can be measured according to “A method (coating method)” among the film surface pH measurement methods prescribed by the Japan Paper Pulp Technology Association (J′ TAPPI). Here, the surface pH was measured through the use of “Type MPC” paper surface pH measurement set manufactured by Kyoritsu Chemical-Check Lab., Corp., which corresponds to the A method.

### <Evaluation of Recording Medium>

On the recording medium obtained in Example 24, “Cobb water absorption test of high-quality paper with base coat layer formed on both surfaces thereof”, “water absorption test of top coat layer”, “curl property test”, “ink droplet jetting test”, and “test of cockling resistance immediately after image formation” were carried out. Table 2 shows the test results.

—Cobb Water Absorption Test of High-Quality Paper with Base Coat Layer Formed on Both Surfaces Thereof—

(1) Cobb absorption degree (amount of water permeated (g/m²) when being contact with 20° C. water for 15 sec.) of the coated surface of the high-quality paper with the base coat layer formed on both surfaces thereof was measured according to the water absorption test method defined in JIS P8140.

(2) Cobb absorption degree (amount of water permeated (g/m²) when being contact with 20° C. water for 2 min.) of the coated surface of the high-quality paper with the base coat layer formed on both surfaces thereof was measured according to the water absorption test method defined in JIS P8140.

(3) Cobb value (amount of diethylene glycol permeated (g/m²) when being contact with 20° C. diethylene glycol for 2 min.) of the coated surface of the high-quality paper with the base coat layer formed on both surfaces thereof was measured according to the water absorption test method defined in JIS P8140.

### —Water Absorption Test of Top Coat Layer —

(1) A top coat layer sample which was cut in A6 size was set on a measurement disc, a head filled with a test liquid was made contact with the surface of the sample, and the sample surface was automatically scanned along a scanning line as shown in FIG. 4 (from an inside toward an outside of the sample) to thereby measure the liquid absorption property of the sample. A relation between a contact time and an amount of liquid absorbed (liquid absorbed amount) was obtained by changing step-by-step the rotation rate of the measurement disc (the contact time between paper and ink). Table 2 shows the water absorbed amount after a contact time of 0.5 sec.

(2) The amount of liquid absorbed was determined in a similar manner to the method described above (1), except that water used in (1) was changed to diethylene glycol. Table 2 shows the amount of liquid absorbed after a contact time of 0.9 sec.

### —Curl Property Test—

Onto the recording medium with the second layer (top coat layer) formed on both surfaces thereof, water was applied so that the amount of water absorbed to a test specimen of 50 mm×5 mm in size became 10 g/m² in respective directions of MD and CD of the specimen. According to the measurement method of a curl curvature defined in No. 15-2:2000 of the Paper Pulp test method (Japan TAPPI), the specimen was left intact under the conditions of 23° C. and 50% RH for 8 hours, and the curl degree of the specimen was measured and evaluated based on the following criteria.

### [Evaluation Criteria]

AAA: The curl degree was lower than 5.

AA: The curl degree was 5 or higher to lower than 10.

BB: The curl degree was 10 or higher to lower than 20.

CC: The curl degree was 20 or higher to lower than 30.

DD: The curl degree was 30 or higher.

### <pH Adjustment of Recording Medium>

### (Preparation of Treatment Liquid)

The following materials were mixed to prepare a treatment liquid:

| | |
|---|---|
| citric acid | 15 g |
| OLFIN E1010 (manufactured by Nisshin Kagaku Co., Ltd.) | 1 g |
| ion exchange water | 84 g |

The pH of the treatment liquid thus prepared was measured using a pH meter WM-50EG (manufactured by Toa Denpa Kogyo K.K. This treatment liquid had a pH of 1.5.

This treatment liquid was applied over the surfaces of the recording medium so that the amount of the liquid permeated became 5 g/m², and each of the coated surfaces was dried at 60° C. and a wind velocity of 15 m/s for 1 minute. The surface pH after being surface treated was 3.6.

In the tests carried out thereafter, the recording medium whose pH had been adjusted was used.

The surface pH can be measured according to “A method (coating method)” among the film surface pH measurement methods prescribed by the Japan Paper Pulp Technology Association (J′ TAPPI). Here, the surface pH was measured through the use of “Type MPC” paper surface pH measurement set manufactured by Kyoritsu Chemical-Check Lab., Corp., which corresponds to the A method.

—Evaluation of Cockling Resistance Immediately after Image Formation—

On a recording medium in a postcard size with the top coat layer formed on both surfaces thereof, a solid image of 100% monochrome and 2 cm×2 cm in size was printed at a center portion of the postcard-size recording medium, and a maximum height of wavy portions that were caused immediately after the image formation was measured using a laser displacement meter. The measurement results were evaluated based on the following criteria.

### [Evaluation Criteria]

AA: The maximum height was 1 mm or higher to less than 2 mm.

BB: The maximum height was 2 mm or higher to less than 3 mm.

CC: The maximum height was 3 mm or higher.

### —Ink Droplet Jetting Test—

### <Preparation of Ink>

### (1) Preparation of Cyan Pigment Ink C

### —Preparation of Pigment Dispersion—

In a vessel, 10 g of CYANINE BLUE A-22 (C.I. PB 15:3) manufactured by Dainichiseika Color & Chemicals Mfg. Co., Ltd., 10.0 g of a low-molecular weight dispersant 2-1, 4.0 g of glycerin and 26 g of ion exchange water were stirred and mixed to prepare a dispersion liquid. Next, the dispersion liquid was intermittently irradiated (irradiated: 0.5 sec. and paused: 1.0 sec.) with a supersonic wave for 2 hours using supersonic irradiation equipment (VIBRA-CELL VC-750, manufactured by SONICS; taper micro chip: φ5 mm, amplitude: 30%) so as to further disperse the pigment, thereby preparing 20% by mass of a pigment dispersion liquid. Note that the low-molecular weight dispersant 2-1 is represented by the following Chemical Formula.

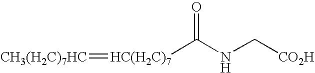

Separately from the pigment dispersion liquid, the following compound was weighed, stirred and mixed to prepare a mixture liquid I.

| | |
|---|---|
| glycerin | 5.0 g |
| diethylene glycol | 10.0 g |
| OLFIN E1010 (manufactured by Nisshin Kagaku Co., Ltd.) | 1.0 g |
| ion exchange water | 11.0 g |

This mixture liquid I was slowly delivered by drops in 23.0 g of a stirred dispersion liquid containing 44% of SBR(polymer fine particle: 3% by mass of acrylic acid, glass transition temperature (Tg) of 30° C.), stirred and mixed to prepare a mixture liquid II.

The mixture liquid II was slowly delivered by drops in 20% of the pigment dispersion liquid, stirred and mixed to prepare 100 g of a cyan color pigment ink C (cyan ink). The pH of the pigment ink C thus prepared was measured using a pH meter WM-50EG manufactured by Toa Denpa Kogyo K.K. The pigment ink C had a pH of 8.5.

### (2) Preparation of Magenta Pigment Ink M

A magenta pigment ink M (magenta color ink) was prepared in a similar manner to the Preparation of Pigment Ink C, except that CROMOPHTAL JET MAGENTA DMQ (PR-122) available from Chiba Specialty Chemicals K.K. was used in place of the pigment used in the formulation of Preparation of Pigment Ink C. The pH of the pigment ink M thus prepared was measured using a pH meter WM-50EG manufactured by Toa Denpa Kogyo K.K. The pigment ink M had a pH of 8.5.

### (3) Preparation of Yellow Pigment Ink Y

A yellow pigment ink Y (yellow color ink) was prepared in a similar manner to the Preparation of Pigment Ink C, except that IRGALITE YELLOW GS (C.I. PY74) available from Chiba Specialty Chemicals K.K. was used in place of the pigment used in the formulation of Preparation of Pigment Ink C. The pH of the pigment ink Y thus prepared was measured using a pH meter WM-50EG manufactured by Toa Denpa Kogyo K.K. The pigment ink Y had a pH of 8.5.

### (4) Preparation of Black Pigment Ink K

A black pigment ink K (black color ink) was prepared in a similar manner to the Preparation of Pigment Ink C, except that CAB-O-JET TM_{—}200 (carbon black) available from CABOT Corp. was used in place of the pigment used in the formulation of Preparation of Pigment Ink C. The pH of the pigment ink K thus prepared was measured using a pH meter WM-50EG manufactured by Toa Denpa Kogyo K.K. The pigment ink K had a pH of 8.5.

### <Ink Droplet Jetting Mode>

An image was formed according to a four-color-single pass printing mode using an image forming apparatus as illustrated in FIG. 2 through the use of the cyan pigment ink C, magenta pigment ink M, yellow pigment ink Y, black pigment ink K and treatment liquid under the following conditions.

### —Ink Image Formation—

Head: piezo full-line head of 1,200 dpi/20 inch width arranged for each of four colors
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

Wind velocity: 15 m/s
Temperature: 60° C.
Air blasted region: 640 mm (drying time: 1 sec.)

### —Fixing—

Silicone rubber roller (hardness: 50 degrees, nip width: 5 mm)
Temperature of roller: 90° C.
Pressure applied: 0.8 MPa

### <Evaluation Method>

Variations in line width and image bleeding on a gray scale image and a thin line image (line formed with a 2 dot width) were visually checked and evaluated according to the following criteria.

### [Evaluation Criteria]

AA: No image bleeding and inter-color mixing of neighboring colors was observed.

BB: No image bleeding and inter-color mixing of neighboring colors was observed, variations in line width were slightly observed, but there was no problem in practical use.

CC: A large number of image bleeding and inter-color mixing of neighboring colors were observed, image bleeding of thin line was conspicuous, and thus the practical usability of the recording medium was low.

DD: A substantial amount of image bleeding and inter-color mixing of neighboring colors were observed, the thin line could not be resolved, and the practical usability of the recording medium was significantly low.

### Example 25

A recording medium was prepared in a same manner as in Example 24, except that the “preparation of base coat layer coating solution” and “preparation of top coat layer coating solution” were respectively changed as follows. The base coat layers formed at this stage respectively had a thickness of 6.2 μm, the top coat layers formed at this stage respectively had a thickness of 20.0 μm, and the surface pH was 7.2. Further, similarly to Example 24, “Cobb water absorption test of high-quality paper with base coat layer formed on both surfaces thereof”, “water absorption test of top coat layer”, “curl property test”, “ink droplet jetting test”, and “test of cockling resistance immediately after image formation” were carried out. Table 2 shows the test results.

### <Preparation of First Layer (Base Coat Layer) Coating Solution>

One hundred parts of kaolin (product name: KAOBRIGHT 90, manufactured by Shiraishi Calcium Co.), 3.8 parts of a liquid containing 0.1N sodium hydrate (manufactured by Wako Pure Chemical Industries, Ltd.), 1.3 parts of a liquid containing 40% of sodium polyacrylate (product name: ARON T-50, manufactured by TOAGOSEI CO., LTD.) and 49.6 parts of water were mixed and dispersed using a non-bubbling kneader (product name: NBK-2 manufactured by Nippon Seiki Co., Ltd.), thereby obtaining a dispersion liquid containing 65% of kaolin.

Next, into 100 parts of an aqueous dispersion liquid containing 29.9% of acrylic silicone latex (glass transition temperature: 25° C., minimum film forming temperature: 20° C., product name: AQUABRID ASI-91, manufactured by DAICEL CHEMICAL INDUSTRIES, LTD.), 7 parts of water, 13.9 parts of the obtained dispersion liquid containing 65% of kaolin and 1 part of an aqueous solution containing 10% of EMULGEN 109P (manufactured by Kao Corp.) were added, sufficiently stirred and mixed, and the liquid temperature of the obtained mixture liquid was maintained at 15° C. to 25° C., thereby obtaining a 32.0% base coat layer coating solution.

### <Preparation of Second Layer (Top Coat Layer) Coating Solution>

A top coat layer coating solution was prepared in a same manner as in Example 24, except that in the preparation of a top coat layer coating solution, instead of using kaolin (product name: KAOBRIGHT 90, manufactured by Shiraishi Calcium Co.), titanium dioxide (product name: TIPAQUE R-780, manufactured by ISHIHARA INDUSTRY CO., LTD.) was used.

### Example 26

A recording medium was prepared in a same manner as in Example 24, except that in the preparation of a top coat layer coating solution, instead of using 100 parts of kaolin (product name: KAOBRIGHT 90, manufactured by Shiraishi Calcium Co.), 30 parts of titanium dioxide (product name: TIPAQUE R-780, manufactured by ISHIHARA INDUSTRY CO., LTD.), 70 parts of kaolin (product name: KAOBRIGHT 90, manufactured by Shiraishi Calcium Co.) and 0.5 parts of a liquid containing 43% of sodium polyacrylate (product name: ARON T-50, manufactured by TOAGOSEI CO., LTD.) were mixed to prepare a mixture, and the mixture was dispersed, and into the dispersion liquid, 11 parts of styrene-butadiene copolymer latex having an average particle diameter of 95 nm (product name: SMARTEX PA2323, manufactured by Nippon A&L Inc.), 3 parts by mass of starch oxide (product name: ACE B, manufactured by Oji Cornstarch Co., Ltd.) and 1 part of lubricant (product name: SN COAT 231SP, manufactured by Sunnopco Co. Ltd) were added, and a top coat coating solution having a final solid content concentration of 65% was thus prepared.

The base coat layers formed at this stage respectively had a thickness of 8.1 μm, the top coat layers formed at this stage respectively had a thickness of 20.6 μm, and the surface pH was 7.4. Further, similarly to Example 24, “Cobb water absorption test of high-quality paper with base coat layer formed on both surfaces thereof”, “water absorption test of top coat layer”, “curl property test”, “ink droplet jetting test”, and “test of cockling resistance immediately after image formation” were carried out. Table 2 shows the test results.

### Example 27

A recording medium was prepared in a same manner as in Example 26, except that in the preparation of a top coat layer coating solution, 100 parts of kaolin (product name: KAOBRIGHT 90, manufactured by Shiraishi Calcium Co.) were used in place of the titanium dioxide and the kaolin.

The base coat layers formed at this stage respectively had a thickness of 8.1 μm, the top coat layers formed at this stage respectively had a thickness of 19.8 μm, and the surface pH was 7.6. Further, similarly to Example 24, “Cobb water absorption test of high-quality paper with base coat layer formed on both surfaces thereof”, “water absorption test of top coat layer”, “curl property test”, “ink droplet jetting test”, and “test of cockling resistance immediately after image formation” were carried out. Table 2 shows the test results.

### Example 28

A recording medium was prepared in a same manner as in Example 25, except that the “preparation of top coat layer coating solution” was changed to that of Example 24.

The base coat layers formed at this stage respectively had a thickness of 6.2 μm, the top coat layers formed at this stage respectively had a thickness of 20.0 μm, and the surface pH was 7.2. Further, “Cobb water absorption test of high-quality paper with base coat layer formed on both surfaces thereof”, “water absorption test of top coat layer”, “curl property test”, “ink droplet jetting test (evaluated according to the following method)”, and “test of cockling resistance immediately after image formation” were carried out similarly to those carried out in Example 24, except that the “pH adjustment of recording medium” was not carried out, and “ink droplet jetting mode” in the “ink droplet jetting test” was changed as follows. Table 2 shows the test results.

### <Ink Droplet Jetting Mode>

An image was formed according to a four-color-single pass printing mode using an image forming apparatus as illustrated in FIG. 3 through the use of the same cyan pigment ink C, magenta pigment ink M, yellow pigment ink Y, black pigment ink K and treatment liquid as those prepared in Example 24.

### <Preparation of Treatment Liquid>

The following materials were mixed to prepare a treatment liquid:

| | |
|---|---|
| citric acid | 15 g |
| glycerin | 20 g |
| diethylene glycol | 10 g |
| OLFIN E1010 (manufactured by Nisshin Kagaku Co., Ltd.) | 1 g |
| ion exchange water | 54 g |

The pH of the treatment liquid thus prepared was measured using a pH meter WM-50EG (manufactured by Toa Denpa Kogyo K.K. This treatment liquid had a pH of 1.6.

### —Treatment Liquid Head for Pre-Coat Module—

Head: piezo full-line head of 600 dpi/20 inch width
Amount of liquid droplets ejected: two-value recording using 0 pL and 4.0 pL
Drive frequency: 15 kHz (conveyance rate of recording medium: 635 mm/sec)
Pattern of image formation: in an ink image forming step, a pattern is used in which a treatment liquid is previously applied to a region of a recording medium at which an image is to be formed with at least one or more color inks.

### —Drying of Water (Drying by Air Blasting) for Pre-Coat Module—

Wind velocity: 15 m/s
Temperature: The recording medium was heated from its back surface thereof using a contact type flat heater such that the surface temperature of the recording medium became 60° C.
Air blasted region: 450 mm (drying time: 0.7 sec.)

### —Ink Image Formation—

Head: piezo full-line head of 1,200 dpi/20 inch width arranged for each of four colors
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

a Wind velocity: 15 m/s
Temperature: 60° C.
Air blasted region: 640 mm (drying time: 1 sec.)

### —Fixing—

Silicone rubber roller (hardness: 50 degrees, nip width: 5 mm)
Temperature of roller: 90° C.
Pressure applied: 0.8 MPa

### Example 29

A recording medium was prepared in a same manner as in Example 25, except that the “pH adjustment of recording medium” was not carried out. The base coat layers formed at this stage respectively had a thickness of 6.2 μm, the top coat layers formed at this stage respectively had a thickness of 20.0 μm, and the surface pH was 7.0. Further, similarly to Example 24, “Cobb water absorption test of high-quality paper with base coat layer formed on both surfaces thereof”, “water absorption test of top coat layer”, “curl property test”, “ink droplet jetting test”, and “test of cockling resistance immediately after image formation” were carried out. Table 2 shows the test results.

### Comparative Example 10

### Preparation of First Layer (Base Coat Layer) Coating Solution

Into 350 parts of water, 10 parts of sodium tetraborate decahydrate (1.62 parts of H₃BO₃ equivalence) were dissolved, subsequently, 100 parts of synthetic silica obtained by wet-process (FINESIL X-37B, manufactured by Tokuyama Soda K.K.) were added, and the components were dispersed using a non-bubbling kneader (product name: NBK-2, manufactured by Nippon Seiki Co., Ltd.) to yield a dispersion liquid. Thereafter, 83.3 parts (as nonvolatile matter content: 40 parts) of styrene-butadiene (SBR) latex containing solid content of 48% (0623N, manufactured by JSR Corporation) were added to the dispersion liquid and mixed. Then, the pH of the mixture dispersion liquid was adjusted with the use of aluminum hydroxide so that the surface pH of the recording medium after a top coat layer being applied onto the surfaces of the recording medium using the following top coat layer coating solution became 8.2, thereby preparing a base coat layer coating solution.

### <Preparation of Second Layer (Top Coat Layer) Coating Solution>

Into 74.8 parts of water, 0.2 parts of acetic acid were mixed, 25 parts of alumina hydrate having a pseudo boehmite structure (DISPERAL HP14, manufactured by SASOL GmbH) and dispersed, and 20 parts of an aqueous solution containing 10% of polyvinyl alcohol (PVA 235, manufactured by KURARAY Co., Ltd.) having a saponification degree of 88%, and a viscosity of 95 mPa·s in a 4% aqueous solution thereof at 25° C. were added thereto, thereby obtaining a top coat layer coating solution.

### <Formation of First Layer (Base Coat Layer)>

On both surfaces of high-quality paper having a basis weight of 81.4 g/m² (product name: SHIRAOI, manufactured by Nippon Paper Industries Co., Ltd.), the obtained base coat layer coating solution was applied using an extrusion die coater so that the coated amount per one surface became 10 g/m², and each of the coated surfaces was dried at 85° C. and a wind velocity of 15 m/sec for 1 minute, thereby forming a base coat layer.

Further, the recording medium with the base coat layer formed on both surfaces thereof was subjected to soft calender treatment.

### —Soft Calender Treatment—

The high-quality paper with the base coat layer formed on both surfaces thereof was subjected to soft calender treatment using a soft calender equipped with a pair of rolls composed of a metal roll and a resin roll under the conditions that the surface temperature of the metal roll was 50° C. and the nip pressure was 50 kg/cm.

### <Formation of Second Layer>

On both surfaces of the high-quality paper with the base coat layer formed on both surfaces thereof, the prepared second layer coating solution was applied using an extrusion die coater so that the dry mass per one surface became 10 g/m², and each of the coated surfaces was dried at a temperature of 70° C. and a wind velocity of 10 m/sec for 1 minute, thereby forming a second layer.

The base coat layers formed at this stage respectively had a thickness of 9.6 μm, and the top coat layers formed at this stage respectively had a thickness of 9.8 μm.

Further, the pH of the recording medium was adjusted with the use of acetic acid so that the surface pH became 3.5. Similarly to Example 1, “Cobb water absorption test of high-quality paper with base coat layer formed on both surfaces thereof”, “water absorption test of top coat layer”, “curl property test”, “ink droplet jetting test”, and “test of cockling resistance immediately after image formation” were carried out. Table 2 shows the test results.

### Comparative Example 11

A recording medium was prepared in a same manner as in Example 24, except that the “preparation of base coat layer coating solution” and “preparation of top coat layer coating solution” were respectively changed as follows; and after applying the base coat layer coating solution, soft calender treatment was not carried out.

The base coat layers formed at this stage respectively had a thickness of 7.6 μm, the top coat layers formed at this stage respectively had a thickness of 20.0 μm, and the surface pH was 9.2. Further, similarly to Example 24, “Cobb water absorption test of high-quality paper with base coat layer formed on both surfaces thereof”, “water absorption test of top coat layer”, “curl property test”, “ink droplet jetting test”, and “test of cockling resistance immediately after image formation” were carried out. Table 2 shows the test results.

### <Preparation of First Layer (Base Coat Layer) Coating Solution>

One hundred parts of titanium dioxide (product name: TIPAQUE R-780, manufactured by ISHIHARA INDUSTRY CO., LTD.), 1.2 parts of a liquid containing 25% of sodium salt of a specific polycarboxylic acid type polymer (product name: DEMOL EP, manufactured by Kao Corp.) and 121.7 parts of water were mixed, the mixture was dispersed using a non-bubbling kneader (product name: NBK-2, manufactured by Nippon Seiki Co., Ltd.), and a dispersion liquid containing 45% of titanium dioxide was thus obtained.

Next, into 100 parts of an aqueous dispersion liquid containing 35% of acrylic latex (glass transition temperature: 60° C., minimum film forming temperature: 50° C., product name: AQUABRID 4635, manufactured by DAICEL CHEMICAL INDUSTRIES, LTD.), 100 parts of water and 3.9 parts of the obtained dispersion liquid containing 45% of titanium dioxide were added, sufficiently stirred and mixed, and the liquid temperature of the obtained mixture liquid was maintained at 15° C. to 25° C., thereby obtaining a 18.0% base coat layer coating solution.

### <Preparation of Second Layer (Top Coat Layer) Coating Solution>

One hundred parts of heavy calcium carbonate (product name: ESCALON #2000, manufactured by Sankyo Seifun Co., Ltd.), and 1.2 parts of a liquid containing 40% of sodium polyacrylate (product name: ARON T-50, manufactured by TOAGOSEI CO., LTD.) were mixed to prepare a mixture. Into the dispersion liquid, 100 parts of an aqueous solution containing 7% of PVA245 (manufactured by KURARAY Co., Ltd.) and 3.7 parts of aqueous solution containing 10% of EMULGEN 109P (manufactured by Kao Corp.) were added, and a top coat coating solution having a final solid content concentration of 27% was thus prepared.

### Comparative Example 12

A recording medium was prepared in a same manner as in Comparative Example 11. The base coat layers formed at this stage respectively had a thickness of 7.6 μm, the top coat layers formed at this stage respectively had a thickness of 20.0 μm, and the surface pH was 9.2. Further, “Cobb water absorption test of high-quality paper with base coat layer formed on both surfaces thereof”, “water absorption test of top coat layer”, “curl property test”, “ink droplet jetting test (evaluated according to the following method)”, and “test of cockling resistance immediately after image formation” were carried out similarly to those carried out in Example 24, except that the “pH adjustment of recording medium” was not carried out, and “ink droplet jetting mode” in the “ink droplet jetting test” was changed as follows. Table 2 shows the test results.

### <Ink Droplet Jetting Mode>

An image was formed according to a four-color-single pass printing mode using an image forming apparatus as illustrated in FIG. 3 through the use of the cyan pigment ink C, magenta pigment ink M, yellow pigment ink Y, black pigment ink K and treatment liquid under the following conditions.

### <Preparation of Treatment Liquid>

The following materials were mixed to prepare a treatment liquid:

| | |
|---|---|
| citric acid | 15 g |
| glycerin | 20 g |
| diethylene glycol | 10 g |
| OLFIN E1010 (manufactured by Nisshin Kagaku Co., Ltd.) | 1 g |
| ion exchange water | 54 g |

The pH of the treatment liquid thus prepared was measured using a pH meter WM-50EG manufactured by Toa Denpa Kogyo K.K. The treatment liquid had a pH of 1.5.

### —Treatment Liquid Head for Pre-Coat Module—

Head: piezo full-line head of 600 dpi/20 inch width
Amount of liquid droplets ejected: two-value recording using 0 pL and 4.0 pL
Drive frequency: 15 kHz (conveyance rate of recording medium: 635 mm/sec)
Pattern of image formation: in an ink image forming step, a pattern is used in which a treatment liquid is previously applied to a region of a recording medium at which an image is to be formed with at least one or more color inks.

### —Drying of Water (Drying by Air Blasting) for Pre-Coat Module—

Wind velocity: 15 m/s
Temperature: The recording medium was heated from its back surface thereof using a contact type flat heater such that the surface temperature of the recording medium became 60° C.
Air blasted region: 450 mm (drying time: 0.7 sec.)

### —Ink Image Formation—

Head: piezo full-line head of 1,200 dpi/20 inch width
Amount of liquid droplets ejected: four-value recording using 0 pL, 2.0 pL, 3.5 pL and 4.0 pL
Drive frequency: 30 kHz (conveyance rate of recording medium: 635 mm/sec)

### —Drying (Drying of Water, Drying by Air Blasting)—

Wind velocity: 15 m/s
Temperature: 60° C.
Air blasted region: 640 mm (drying time: 1 sec.)

### —Fixing—

Silicone rubber roller (hardness: 50 degrees, nip width: 5 mm)
Temperature of roller: 90° C.
Pressure applied: 0.8 MPa

TABLE 2

| | | | Cobb water | | | Amount | | | | |
|---|---|---|---|---|---|---|---|---|---|---|
| | | | absorption value | | | of water | | | Ink | |
| | Surface pH | | (g/m²) | | | absorbed | | Curl | droplet | Cockling |
| | pH before | pH after | Water | | DEG | (mL/m²) | | property | jetting | resistance |
| | adjustment | adjustment | 15 sec. | 2 min. | 2 min. | Water | DEG + Water | test | test | test |
| Ex. 24 | 7.4 | 3.6 | 0.1 | 0.9 | 1.4 | 3.9 | 3.1 | AAA | AA | AA |
| Ex. 25 | 7.2 | 3.4 | 0.1 | 0.8 | 0.6 | 6.8 | 6.2 | AAA | AA | AA |
| Ex. 26 | 7.4 | 3.4 | 0.1 | 0.9 | 1.4 | 4.5 | 4.3 | AAA | AA | AA |
| Ex. 27 | 7.2 | 3.8 | 0.1 | 0.9 | 1.4 | 3.7 | 3.0 | AAA | AA | AA |
| Ex. 28 | 7.2 | — | 0.1 | 0.9 | 1.4 | 3.8 | 3.2 | AAA | AA | AA |
| Ex. 29 | 7.0 | — | 0.1 | 0.8 | 0.6 | 6.5 | 6.2 | AAA | BB | AA |
| Compara. | 8.2 | 3.6 | 7.7 | 10.5 | 10.6 | 7.2 | 6.4 | DD | DD | DD |
| Ex. 10 | | | | | | | | | | |
| Compara. | 9.2 | 6.6 | 8.1 | 11.2 | 10.7 | 2.0 | 1.6 | DD | DD | CC |
| Ex. 11 | | | | | | | | | | |
| Compara. | 8.4 | — | 8.1 | 11.2 | 10.7 | 1.8 | 1.5 | DD | DD | CC |
| Ex. 12 | | | | | | | | | | |

*DEG: diethylene glycol

What is claimed is:

1. A recording medium comprising:
a base paper,
a first layer containing a binder, and
a second layer containing a white pigment,
the first layer and second layer being laid in this order on the base paper,
wherein the base paper provided with the first layer on its surface has a Cobb water absorption degree, measured according to a water absorption test prescribed in JIS P8140 with a contact time of 15 seconds, of 5.0 g/m² or lower, and the second layer has an amount of water absorbed therein, measured by the Bristow's method with a contact time of 0.5 seconds, of 2 mL/m² to 8 mL/m².

2. The recording medium according to claim 1, wherein the base paper provided with the first layer on its surface has a Cobb water absorption degree, measured according to a water absorption test prescribed in JIS P8140 with a contact time of 2 minutes, of 2.0 g/m² or lower.

3. The recording medium according to claim 1, wherein the base paper provided with the first layer on its surface has a Cobb value, measured based on a water absorption test prescribed in JIS P8140 using diethylene glycol with a contact time of 2 minutes, of 5.0 g/m² or lower, and the second layer has an amount of water absorbed, measured by the Bristow's method using pure water containing 30% by mass of diethylene glycol with a contact time of 0.9 seconds, of 1 mL/m² to 6 mL/m².

4. The recording medium according to claim 1, wherein before pH adjustment, the second layer has a layer surface pH of less than 8.0.

5. The recording medium according to claim 1, wherein the white pigment is comprised only of a white pigment which has a pH, measured by a pH test method based on a cold-water extraction method prescribed in JIS K5101, of less than 8.0.

6. The recording medium according to claim 1, wherein the white pigment has a pH, measured after adding 0.1 mL of a liquid containing 1 moL/L of hydrochloric acid to 10 g of a measurement sample of the pigment according to a pH test method based on a cold-water extraction method prescribed in JIS K5101, of less than 6.0.

7. The recording medium according to claim 1, wherein after pH adjustment, the second layer has a layer surface pH of 5.5 or lower.

8. The recording medium according to claim 1, wherein the binder contained in the first layer comprises a thermoplastic resin.

9. The recording medium according to claim 8, wherein the thermoplastic resin is at least one selected from polyester urethane latexes, and acrylic silicone latexes.

10. The recording medium according to claim 1, wherein the first layer further comprises a laminar inorganic compound.

11. The recording medium according to claim 1, wherein the first layer further comprises a white pigment.

12. The recording medium according to claim 11, wherein the white pigment is kaolin.

13. The recording medium according to claim 12, wherein the kaolin has an aspect ratio of 30 or more.

14. A method for producing a recording medium, comprising:
forming a first layer on a surface of a base paper, and
forming a second layer on a surface of the first layer to thereby produce a recording medium,
wherein in the formation of the first layer, thermoplastic resin fine particles provided on the surface of the base paper are heated in the range of temperature which is higher than the minimum film forming temperature of the thermoplastic resin fine particles, and
wherein the recording medium comprises:
the base paper,
the first layer containing a binder, and
the second layer containing a white pigment,
the first layer and second layer being laid in this order on the base paper,
wherein the base paper provided with the first layer on its surface has a Cobb water absorption degree, measured according to a water absorption test prescribed in JIS P8140 with a contact time of 15 seconds, of 5.0 g/m² or lower, and the second layer has an amount of water absorbed therein, measured by the Bristow's method with a contact time of 0.5 seconds, of 2 mL/m² to 8 mL/m².

15. The method according to claim 14, wherein when a shearing rate D(=S/(t×60×10⁻⁶)) of a coating solution for forming a second layer, which is defined depending on a coating rate S (m/min) and a film thickness t (μm) of a coated layer, is within the range of from 10³ (s⁻¹) to 10⁶ (s⁻¹), the high-shear viscosity of the coating solution for forming a second layer is from 20 mPa·s 150 mPa·s.

16. The method according to claim 14, wherein in the formation of the second layer, a coating solution for forming a second layer is applied onto the first layer by a blade coating method.

17. An inkjet recording method comprising:
forming an ink image based on predetermined image data on a surface of a recording medium, and
drying an ink solvent in the recording medium having the ink image formed on the surface thereof so as to remove the ink solvent,
wherein the recording medium comprises:
a base paper,
a first layer containing a binder, and
a second layer containing a white pigment,
the first layer and second layer being laid in this order on the base paper,
wherein the base paper provided with the first layer on its surface has a Cobb water absorption degree, measured according to a water absorption test prescribed in JIS P8140 with a contact time of 15 seconds, of 5.0 g/m² or lower, and the second layer has an amount of water absorbed therein, measured by the Bristow's method with a contact time of 0.5 seconds, of 2 mL/m² to 8 mL/m².

18. The inkjet recording method according to claim 17, further comprising: supplying a treatment liquid containing an acidic material to the recording medium before the formation of the ink image.
